(19) United States
(12) Patent Application Publication
(10) Pub. No.: US 2011/0064332 A1
(43) Pub. Date: Mar. 17, 2011

(54) ENVIRONMENTALLY FRIENDLY TEXTILE SOFT GOODS RETAIL PACKAGING INCORPORATING VACUUM-SEALABLE BAGS REUSABLE BY CONSUMERS

(76) Inventors: John A. PIAZZA, Winston-Salem, NC (US); Paul Mischinski, Winston Salem, NC (US); Nancy Golden, Monroe Township, NJ (US); Daniel Lee Bizzell, Davidson, NC (US); Todd Stancombe, Charlotte, NC (US)

(21) Appl. No.: 12/882,961

(22) Filed: Sep. 15, 2010

Related U.S. Application Data
(60) Provisional application No. 61/242,791, filed on Sep. 15, 2009.

(51) Int. Cl. B65D 30/24; B42D 15/00

(52) U.S. Cl. 383/44; 283/81

(57) ABSTRACT

A consumer textile soft goods product for retail sale includes a vacuum-resealable bag and one or more textile soft goods located therein. The vacuum-resealable bag includes air impermeable walls, a one-way valve assembly, and a closure mechanism. The vacuum-resealable bag is configured to maintain a vacuum condition therein when the closure mechanism seals the vacuum-resealable bag and air is evacuated through the one-way valve assembly. A pressure differential preferably maintains the textile soft goods for retail sale in a compressed condition within the vacuum-sealable bag, and the vacuum-sealable bag preferably is located within retail packaging. Furthermore, the vacuum-resealable bag preferably is configured to be opened and then reclosed such that the vacuum-resealable bag is reusable by a consumer for vacuum-packing compressible items after the one or more textile soft goods have been removed from the interior space of the vacuum-resealable bag post purchase.

### CROSS-REFERENCE TO RELATED APPLICATION

For purposes of the United States, the present application is a U.S. nonprovisional patent application of, and claims priority under 35 U.S.C. §119(e) to, U.S. provisional patent application Ser. No. 61/242,791, filed Sep. 15, 2010, which provisional patent application is incorporated by reference herein. The present application further incorporates by reference U.S. nonprovisional patent application Ser. No. 29/343,570 and any patent issuing therefrom.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

Currently, there exist vacuum-sealable bags for purchase by a consumer to facilitate storage of soft goods in their home or residence. These vacuum-sealable bags include a re-sealable mouth providing access to an interior of the bag. A user can place a soft good 2 inside of a vacuum-resealable bag 4 via the mouth 6, as illustrated in FIG. 1A, and then seal the mouth as partially illustrated in FIG. 1B. Such a vacuum-sealable bag further includes a one-way valve 8. After a user has sealed the mouth, the user can engage the one-way valve with a nozzle 10 of a household vacuum appliance (such as, for example, the vacuum appliance 12 illustrated in FIG. 2) to evacuate air from of the interior of the vacuum-sealable bag, resulting in the compressing of the soft good located within the vacuum-sealable bag as illustrated in FIG. 1C. When the user is satisfied with the result, or as much air as is practical has been evacuated from the bag, the user can remove the nozzle, as illustrated in FIG. 1D. The bag containing the compressed soft good can then be stored by the user.

A need exists for improvement in the packaging of textile soft goods and, in particular, a need exists for improvements in the packaging of textile soft goods for retail sale. This, and other needs, are addressed by one or more aspects of the invention.

### SUMMARY OF THE INVENTION

The present invention includes many aspects and features. Moreover, while many aspects and features relate to, and are described in, the context of a textile soft goods product for retail sale, the invention is not limited to use only in this context, as will become apparent from the following summaries and detailed descriptions of aspects, features, and one or more embodiments of the invention.

The invention generally relates to the packing of one or more textile soft goods in a vacuum-sealable bag for retail sale of a textile soft goods product to a consumer at retail, and further relates to apparatus, methods and systems connected thereto.

In accordance with one or more aspects of the invention, a textile soft good is sold as a product to a consumer at retail. The textile soft goods retail product may comprise any combination or subcombination of one or more of each of the following textile soft goods, including only one of the following textile soft goods: a sheet set; a sheet, including a top sheet, a fitted sheet, a pillowcase, and any combination thereof; a pillowcase; a comforter; bed ruffles; a bedskirt; a pillow sham; fabric window covering; fabric window treatment; drapery; valence; swag; curtain; mattress pad; electric mattress pad; throw; a towel; a beach towel; a kitchen towel; a table linen; a table cloth; a napkin; a quilt; a duvet cover; a feather mattress pad; a blanket; an electric blanket; a heated blanket; a bedspread; an area rug; a bath rug; and a kitchen rug. The consumer textile soft goods product may be a bedding ensemble or a bedding set. Additionally, in accordance with one or more aspects of the invention, one or more textile soft goods are compression-packaged in a reusable vacuum-sealable bag and thereafter sold at retail in the reusable vacuum-sealable bag. The compression-packaging may include vacuum-packaging and further may be provided as merchandise packaging services by one party to one or more other third parties.

In an aspect of the invention, a consumer textile soft goods product for retail sale comprises a vacuum-resealable bag and one or more textile soft goods located within the interior space of the vacuum-resealable bag. The vacuum-resealable has air impermeable walls defining an interior space of the vacuum-resealable bag; a one-way valve assembly configured to permit air to be evacuated through the one-way valve assembly from the interior space of the vacuum-resealable bag but to preclude air from entering the interior space of the vacuum sealable bag through the one-way valve assembly; and a closure mechanism configured to seal a mouth of the vacuum-resealable bag in an airtight manner. The vacuum-resealable bag is configured to maintain a vacuum condition within the interior space when the closure mechanism seals the mouth of the vacuum-resealable bag and air is evacuated through the one-way valve assembly from the interior space defined by the vacuum-resealable bag, and the vacuum-resealable bag is configured to be opened and then reclosed such that the vacuum-resealable bag is reusable by a consumer for vacuum-packing compressible articles after the one or more textile soft goods purchased at retail therein have been removed from the vacuum-resealable bag.

In a feature, the one or more textile soft goods located within the interior space of the vacuum-resealable bag are maintained in a compressed condition resulting from a pressure differential existing between a pressure in the interior space of the vacuum-resealable bag and a pressure exterior to the vacuum-resealable bag.

In a feature, the consumer textile soft goods product for retail sale further includes retail packaging comprising a case in which the vacuum-resealable bag containing the textile soft goods is contained, wherein a hoop strength of the case is sufficient to maintain the textile soft goods in a compressed condition within the vacuum-resealable bag upon equalization of the pressure in the interior space of the vacuum-resealable bag and a pressure exterior to the vacuum-resealable bag.

In a feature, the one-way valve assembly is located in a wall of the vacuum-resealable bag and is configured to receive a nozzle of a vacuum cleaner hose, whereby the air within the interior space may be evacuated using a vacuum cleaner.

In a feature, the one-way valve assembly of the vacuum-resealable bag is configured to expel air from the interior space thereof upon rolling up of the vacuum-resealable bag by a consumer for creating a pressure differential between a pressure in the interior space of the bag and a pressure exterior to the bag.

In a feature, the textile soft goods comprise a plurality of individual bedding components constituting a bedding set.

In a feature, none of the textile soft goods are individually packaged.

In a feature, the consumer textile soft goods product for retail sale further includes printed media identifying the one or more textile soft goods contained in the interior space of the vacuum-resealable bag, the printed media being physically associated with the vacuum-resealable bag for viewing by a consumer at retail sale. The printed media may further identify the reusability of the vacuum-resealable bag, the printed media may comprise an adhesive label that is attached to the vacuum-resealable bag, and the retail packaging of the textile soft goods product for retail sale may comprise the vacuum-resealable bag.

In a feature, at least a portion of the vacuum-resealable bag is transparent such that one or more contents of the vacuum-resealable bag are viewable there through. In a variation, the material may be translucent rather than transparent.

In a feature, the consumer textile soft goods product for retail sale further includes retail packaging defining an interior space in which the vacuum-resealable bag containing the textile soft goods is contained.

In a feature, the consumer textile soft goods product for retail sale further includes retail packaging comprising a case in which the vacuum-resealable bag containing the textile soft goods is contained, the case configured to be opened and then reclosed such that the case is reusable by a consumer after the vacuum-resealable bag containing the bedding set has been removed therefrom by the consumer. Additionally, a portion of the vacuum-resealable bag may be transparent such that one or more contents of the vacuum-resealable bag are viewable there through, and at least a portion of the case may be transparent such that one or more contents of the vacuum-resealable bag are further viewable there through, with the vacuum-resealable bag being arranged within the case such that the one or more contents of the vacuum-resealable bag are viewable through both the case and the vacuum-resealable bag by a prospective customer at retail sale. Furthermore, the product may include an adhesive label that is attached to the case containing the vacuum-resealable bag and that identifies the one or more textile soft goods contained in the interior space of the vacuum-resealable bag; the case may comprise a pocket that includes a transparent panel through which contents of the pocket are viewable from an exterior of the case, and a rigid planar member comprising a card insert may be retained within the pocket of the case that identifies the one or more textile soft goods contained in the interior space of the vacuum-resealable bag; or both. Moreover, the pocket may include opposing front and rear transparent panels whereby contents of the pocket are viewable through both the front and rear transparent panels.

In a feature, the case defines an interior containment space that is practically entirely consumed by the vacuum-resealable bag contained therein. The case may include opposed transparent panels, and corners of the transparent panels include non-transparent components that cover the corners of the vacuum-resealable bag and that reinforce the case and contribute to the hoop strength of the case.

In another aspect of the invention, a consumer textile soft goods product for retail sale includes a vacuum-sealable bag, one or more textile soft goods located within the interior space of the vacuum-sealable bag, and printed media physically associated with the vacuum-resealable bag, for viewing by a consumer at retail sale, that identifies the one or more textile soft goods contained in the interior space of the vacuum-resealable bag. The vacuum-resealable bag has air impermeable walls defining an interior space of the vacuum-sealable bag; a one-way valve assembly configured to permit air to be evacuated through the one-way valve assembly from the interior space of the vacuum-sealable bag but to preclude air from entering the interior space of the vacuum sealable bag through the one-way valve assembly; and a closure mechanism configured to seal a mouth of the vacuum-sealable bag in an airtight manner. The vacuum-sealable bag is configured to maintain a vacuum condition within the interior space when the closure mechanism seals the mouth of the vacuum-sealable bag and air is evacuated through the one-way valve assembly from the interior space defined by the vacuum-sealable bag. The one or more textile soft goods located within the interior space of the vacuum-sealable bag are maintained in a compressed condition resulting from a pressure differential existing between a pressure in the interior space of the vacuum-sealable bag and a pressure exterior to the vacuum-sealable bag.

In a feature, the printed media comprises an adhesive label that is attached to the vacuum-sealable bag. The retail packaging of the textile soft goods product for retail sale may comprise the vacuum-sealable bag.

In a feature, the consumer textile soft goods product for retail sale further includes retail packaging defining an interior space in which the vacuum-sealable bag containing the textile soft goods is contained.

In a feature, the consumer textile soft goods product for retail sale further includes retail packaging comprising an outer bag in which the vacuum-sealable bag containing the textile soft goods is contained.

In a feature, the consumer textile soft goods product for retail sale further includes retail packaging comprising a case in which the vacuum-sealable bag containing the textile soft goods is contained, the case configured to be opened and then reclosed such that the case is reusable by a consumer after the vacuum-sealable bag containing the bedding set has been removed therefrom by the consumer.

In another aspect, a consumer textile soft goods product for retail sale includes the combination of an inner bag and retail packaging in which the inner bag itself is contained. The inner bag comprises a vacuum-sealable bag having air impermeable walls defining an interior space of the vacuum-sealable bag; a one-way valve assembly configured to permit air to be evacuated through the one-way valve assembly from the interior space of the vacuum-sealable bag but to preclude air from entering the interior space of the vacuum sealable bag through the one-way valve assembly; and a closure mechanism configured to seal a mouth of the vacuum-sealable bag in an airtight manner. The vacuum-sealable bag is configured to maintain a vacuum condition within the interior space when the closure mechanism seals the mouth of the vacuum-sealable bag and air is evacuated through the one-way valve assembly from the interior space defined by the vacuum-sealable bag. One or more textile soft goods located within the interior space of the vacuum-sealable bag.

In a feature, the retail packaging comprises a case in which the vacuum-sealable bag containing the textile soft goods is contained, wherein a hoop strength of the case is sufficient to maintain the textile soft goods in a compressed condition within the vacuum-sealable bag upon equalization of the pressure in the interior space of the vacuum-sealable bag and a pressure exterior to the vacuum-sealable bag.

In a feature, the consumer textile soft goods product for retail sale further includes printed media identifying the one or more textile soft goods contained in the interior space of the vacuum-sealable bag, the printed media being physically associated with the retail packaging for viewing by a consumer at retail sale. The printed media may comprise an adhesive label that is attached to the retail packaging.

In a feature, at least a portion of the vacuum-sealable bag is transparent such that one or more contents of the vacuum-sealable bag are viewable there through.

In a feature, the retail packaging comprises an outer bag.

In a feature, the retail packaging comprises a case that is configured to be opened and then reclosed such that the case is reusable by a consumer after the vacuum-sealable bag has been removed therefrom by the consumer. The case may not include an airtight seal closing off the interior containment space in which the vacuum-sealable bag is contained.

Another aspect comprises a method of packaging a consumer textile soft goods product for retail sale. The method includes the step of providing a vacuum-resealable bag having air impermeable walls defining an interior space of the vacuum-resealable bag; a one-way valve assembly configured to permit air to be evacuated through the one-way valve assembly from the interior space of the vacuum-resealable bag but to preclude air from entering the interior space of the vacuum sealable bag through the one-way valve assembly; and a closure mechanism configured to seal a mouth of the vacuum-resealable bag in an airtight manner. The vacuum-resealable bag is configured to maintain a vacuum condition within the interior space when the closure mechanism seals the mouth of the vacuum-resealable bag and air is evacuated through the one-way valve assembly from the interior space defined by the vacuum-resealable bag, and the vacuum-resealable bag is further configured to be opened and then reclosed such that the vacuum-resealable bag is reusable by a consumer for vacuum-packing after the one or more textile soft goods have been removed from the interior space of the vacuum-resealable bag. The method also comprises the step of sealing one or more textile soft goods within the interior space of the vacuum-resealable bag for retail sale to a consumer.

In a feature, said sealing comprises vacuum-sealing.

In a feature, the method further includes comprising maintaining the one or more textile soft goods in a compressed condition within the interior space of the vacuum-resealable bag by creating a pressure differential between a pressure in the interior space of the vacuum-resealable bag and a pressure exterior to the vacuum-resealable bag.

In a feature, the method further includes the step of identifying the one or more textile soft goods contained in the vacuum-resealable bag by physically associating printed media with the vacuum-resealable bag.

In a feature, none of the textile soft goods within the vacuum-resealable bag are individually packaged.

In a feature, the method further includes shipping the textile soft goods product to a wholesaler, distributor, retailer, or consumer.

In a feature, the method further includes locating the vacuum-resealable bag having the one or more textile soft goods components within an interior space of retail packaging.

In a feature, the method further includes the steps of locating the vacuum-resealable bag having the one or more textile soft goods therein within a case having a pocket, the pocket including a transparent panel; and locating a card insert within the pocket such that the card insert is viewable through the transparent panel from an exterior of the case, the card insert comprising printed media identifying the one or more textile soft goods therein to a consumer at retail sale.

In a feature, the method further includes the step of compressing the one or more textile soft goods prior to said sealing the one or more textile soft goods within the interior space of the vacuum-resealable bag for retail sale to a consumer.

The method further may include the step of maintaining the one or more textile soft goods in a compressed condition within the interior space of the vacuum-resealable bag by creating a pressure differential between a pressure within the vacuum-resealable bag and an exterior of the vacuum-resealable bag.

The method further may include the step of folding and arranging the one or more textile soft goods within an interior space of the vacuum-resealable bag prior to said step (b) of sealing the one or more textile soft goods within the interior space of the vacuum-resealable bag for retail sale to a consumer.

Another aspect of the invention comprises a method of packaging a consumer textile soft goods product for retail sale. The method includes the steps of: providing a vacuum-sealable bag; sealing one or more textile soft goods within the interior space of the vacuum-sealable bag for retail sale to a consumer; and physically associating with the vacuum-sealable bag, for viewing by a consumer at retail sale, printed media that identifies the one or more textile soft goods contained in the interior space of the vacuum-sealable bag. The vacuum-sealable bag that is provided has air impermeable walls defining an interior space of the vacuum-sealable bag; a one-way valve assembly configured to permit air to be evacuated through the one-way valve assembly from the interior space of the vacuum-sealable bag but to preclude air from entering the interior space of the vacuum sealable bag through the one-way valve assembly; and a closure mechanism configured to seal a mouth of the vacuum-sealable bag in an airtight manner. The vacuum-sealable bag is configured to maintain a vacuum condition within the interior space when the closure mechanism seals the mouth of the vacuum-sealable bag and air is evacuated through the one-way valve assembly from the interior space defined by the vacuum-sealable bag.

In a feature, the method further includes maintaining the one or more textile soft goods in a compressed condition within the interior space of the vacuum-sealable bag by creating a pressure differential between a pressure in the interior space of the vacuum-sealable bag and a pressure exterior to the vacuum-sealable bag.

In a feature, the printed media comprises an adhesive label that is applied to the vacuum-sealable bag.

In a feature, the method further includes shipping the textile soft goods product to a wholesaler, distributor, retailer, or consumer.

In a feature, the method further includes locating the vacuum-sealable bag having the one or more textile soft goods components within an interior space of retail packaging.

In a feature, the method further includes the steps of locating the vacuum-sealable bag having the one or more textile soft goods therein within a case having a pocket, the pocket including a transparent panel; and locating a card insert within the pocket such that the card insert is viewable through the transparent panel from an exterior of the case, the card insert comprising the printed media identifying the one or more textile soft goods therein to a consumer at retail sale.

In a feature, the method further includes the step of compressing the one or more textile soft goods prior to said sealing the one or more textile soft goods within the interior space of the vacuum-sealable bag for retail sale to a consumer.

In a feature, the method further includes the step of maintaining the one or more textile soft goods in a compressed condition within the interior space of the vacuum-sealable bag by creating a pressure differential between a pressure within the vacuum-sealable bag and an exterior of the vacuum-sealable bag.

In a feature, the method further includes the step of folding and arranging the one or more textile soft goods within an interior space of the vacuum-resealable bag prior to said sealing the one or more textile soft goods within the interior space of the vacuum-resealable bag for retail sale to a consumer.

Another aspect of the invention comprises a method of packaging a consumer textile soft goods product for retail sale. The method includes the step of providing a vacuum-sealable bag having air impermeable walls defining an interior space of the vacuum-sealable bag; a one-way valve assembly configured to permit air to be evacuated through the one-way valve assembly from the interior space of the vacuum-sealable bag but to preclude air from entering the interior space of the vacuum sealable bag through the one-way valve assembly; and a closure mechanism configured to seal a mouth of the vacuum-sealable bag in an airtight manner. Moreover, the vacuum-sealable bag is configured to maintain a vacuum condition within the interior space when the closure mechanism seals the mouth of the vacuum-sealable bag and air is evacuated through the one-way valve assembly from the interior space defined by the vacuum-sealable bag. The method further includes the steps of sealing one or more textile soft goods within the interior space of the vacuum-sealable bag for retail sale to a consumer; and locating the vacuum-sealable bag within retail packaging for retail sale to a consumer.

In a feature, the method further includes physically associating with the retail packaging, for viewing by a consumer at retail sale, printed media that identifies the one or more textile soft goods contained in the vacuum-sealable bag, wherein the printed media comprises an adhesive label that is applied to the retail packaging.

Another aspect of the invention relates to consumer retail packaging comprising a compression packaged (e.g., vacuum-packaged) bedding set. In this respect, a textile soft goods product for retail sale to a consumer includes a vacuum-sealable bag and a plurality of individual bedding components constituting a bedding set. The vacuum-sealable bag has a one-way valve assembly whereby air may be evacuated from, and kept from reentering, an interior space defined by the vacuum-sealable bag. The textile soft goods are folded and arranged together within the interior space of the vacuum-sealable bag and are maintained in a compressed condition resulting from a pressure differential existing between a pressure in the interior space and a pressure exterior to the bag. Preferably none of the bedding components are individually packaged. The mouth of the vacuum-sealable bag, when fully open, is configured for insertion and withdrawal of the textile soft goods. Printed media physically associated with the vacuum-sealable bag identifies the textile soft goods as being a bedding set.

Another aspect of the invention relates to consumer retail packaging having a vacuum-resealable bag containing a bedding set. In this respect, a consumer textile soft goods product for retail sale includes retail packaging, e.g., a case, which contains a reusable vacuum-sealable bag. The reusable vacuum-sealable bag, in turn, contains bedding components folded, arranged, and maintained in a compressed condition resulting from a pressure differential. The bag includes a one-way valve assembly and an airtight closure mechanism. The retail packaging includes a transparent pocket retaining a card insert having printed media identifying the bedding set components. Preferably, the retail packaging itself does not include an airtight seal closing off the interior containment space in which the bag is contained, and a hoop strength of the retail packaging is sufficient to maintain the textile soft goods in a compressed condition within the bag upon loss of the pressure differential. The retail packaging and bag preferably include transparent portions whereby one or more bedding components are viewable by a prospective customer at retail sale.

An aspect of the invention relates to an outer consumer retail bag combined with a reusable vacuum-sealable inner bag containing a bedding set. In this respect, a textile soft goods product for retail sale includes the combination of an inner bag containing textile soft goods and an outer bag in which the inner bag itself is contained. The inner bag is a vacuum-sealable bag having a one-way valve assembly in a bag wall thereof. Air that is evacuated from an interior space of the vacuum-sealable bag is prevented, by the one-way valve assembly, from reentering the bag. The vacuum-sealable bag further includes a closure mechanism configured to seal a mouth of the vacuum-sealable bag in an airtight manner. The outer bag defines an interior containment space in which the inner bag is contained. The interior containment space may be practically entirely consumed by the inner bag. The textile soft goods preferably include bedding components constituting a bedding set. The textile soft goods are maintained in a compressed condition as a result of a pressure differential.

An aspect of the invention relates to packaging consumer textile soft goods comprising a vacuum-packaged bedding set. In this respect, a method of packaging a consumer textile soft goods product for retail sale includes the steps of: compressing a plurality of individual bedding components constituting a bedding set and maintaining the compressed textile soft goods in a compressed condition within an interior space of a vacuum-sealable bag by creating a pressure differential between a pressure in the interior space of the vacuum-sealable bag and a pressure exterior to the vacuum-sealable bag; and identifying the contents of the vacuum-sealable bag as being a bedding set by physically associating printed media with the vacuum-sealable bag having the plurality of individual bedding components compressed therein. The vacuum-sealable bag includes a one-way valve assembly for evacuating air and a closure mechanism configured to seal a mouth of the vacuum-sealable bag in an airtight manner. The vacuum-sealable bag preferably is reusable by the consumer after the bedding components have been removed.

An aspect of the invention relates to combining consumer retail packaging with vacuum-resealable bag containing a bedding set. In this respect, a method of packaging a textile soft goods product for retail sale includes the steps of: compressing textile soft goods comprising a plurality of individual bedding components constituting a bedding set; maintaining the bedding components in a compressed condition within a vacuum-sealable bag by maintaining a pressure differential between a pressure in the interior space of the vacuum-sealable bag and a pressure exterior to the vacuum-sealable bag; and locating the vacuum-sealable bag, itself having the plurality of individual bedding components collectively vacuum-packaged therein, within retail packaging that identifies the textile soft goods contained in the vacuum-sealable bag as being a bedding set. The textile soft goods preferably are folded and arranged together within the vacuum-sealable bag with none of the bedding components being individually packaged. The vacuum-sealable bag preferably includes a one-way valve assembly and a closure mechanism configured to seal the vacuum-sealable bag in an airtight manner.

An aspect of the invention relates to combining an outer consumer retail bag with reusable inner vacuum-sealable bag containing a bedding set. In this respect, a method of packaging a textile soft goods product for retail sale includes the steps of: arranging textile soft goods within an interior space of a vacuum-sealable bag; containing the vacuum-sealable bag within an outer bag; and identifying the textile soft goods contained in the inner vacuum-sealable bag as being a bedding set by physically associating printed media with the outer bag. The vacuum-sealable bag preferably is reusable and includes pliable and air impermeable walls; a one-way valve assembly in one of the walls for evacuating air through the one-way valve assembly from the interior space defined by the vacuum-sealable bag such that the evacuated air is kept from reentering the vacuum-sealable bag through the one-way valve assembly; and a closure mechanism configured to seal a mouth of the vacuum-sealable bag in an airtight manner. The textile soft goods may be compressed before vacuum-sealing, and may be compressed as a result of the vacuum-sealing.

An aspect of the invention relates to a shipping package of bedding sets each set contained in a vacuum-sealable bag for retail sale. In this respect, a shipping package of bedding sets includes a plurality of textile soft goods products for retail sale. Each product includes: a vacuum-sealable bag having a one-way valve assembly and a reusable closure mechanism; textile soft goods comprising a plurality of individual bedding components constituting a bedding set for a particular size of bed; and retail packaging in which the vacuum-sealable bag containing the bedding set is itself contained. The retail packaging of each product is substantially the same size and volume as the retail packaging of each other product, but at least one of the bedding sets of the products is for a particular size of bed that is different than that of at least one of the other products. Each respective retail packaging includes printed media that identifies the bedding set contained in the vacuum-sealable bag as being a bedding set for a particular size of bed.

An aspect of the invention relates to a retail display of bedding sets each set contained in reusable vacuum-sealable bag of a retail packaging. In this respect, a display of bedding sets for retail sale includes a plurality of textile soft goods products, each including: a vacuum-sealable bag; textile soft goods including a plurality of individual bedding components constituting a bedding set for a particular size of bed, the textile soft goods being maintained in a compressed condition resulting from a pressure differential existing between a pressure in the interior space of the vacuum-sealable bag and a pressure exterior to the vacuum-sealable bag; and retail packaging in which the vacuum-sealable bag containing the bedding set is itself contained, the retail packaging including printed media that identifies the bedding set contained in the vacuum-sealable bag as being a bedding set. The retail packaging of each product is displayed on a shelf of a retail store, and each takes up the same amount of shelf space regardless of the particular size of bed of each product.

An aspect of the invention relates to shipping bedding sets for retail sale each contained in a reusable vacuum-sealable bag of retail packaging. In this respect, a method of shipping bedding sets for retail sale includes making textile soft goods products for retail sale comprising, for each product: compression-packing individual bedding components constituting a bedding set for a particular size of bed within an interior space of a vacuum-sealable bag; maintaining the bedding components in a compressed condition by maintaining a pressure differential, wherein the vacuum-sealable bag includes a one-way valve assembly and a reusable closure mechanism; locating the vacuum-sealable bag within retail packaging; and identifying the bedding components as being a bedding set for the particular size of bed by physically associating printed media with the retail packaging. The method includes packing the products in a shipping container such that they collectively consume the entire interior containment space of the shipping container. Each product has substantially the same dimensions, but the bed sizes of at least some of the bedding sets differ.

An aspect of the invention relates to retail product packaging including a vacuum-resealable bag in an environmentally friendly consumer retail system. In this respect, an environmentally friendly system in which product packaging is reused post purchase by consumers includes making textile soft goods products for retail sale by, for each product: locating textile soft goods within an interior space of a vacuum-resealable bag; locating the vacuum-resealable bag within retail packaging; and identifying the textile soft goods contained in the vacuum-resealable bag by physically associating printed media with the retail packaging. The system further includes advertising, as a selling point to consumers, the reusability of the vacuum-resealable bags by consumers post retail purchase.

Further in this respect, an environmentally friendly system in which product packaging is reused post purchase by consumers includes purchasing textile soft goods products, each including textile soft goods compression-packaged within a reusable vacuum-resealable bag; removing the textile soft goods from the vacuum-resealable bags for use; and reusing, by the consumers, the vacuum-resealable bags by vacuum-packing items therein. The vacuum-resealable bags may be used by consumers for vacuum-packing for storage the same or different textile soft goods, including storage during transport.

Still further in this respect, an environmentally friendly system in which product packaging is reused post purchase by consumers includes packaging textile soft goods products for retail sale including, for each product, the steps of: locating the textile soft goods within an interior space of a vacuum-resealable bag; locating the vacuum-resealable bag within retail packaging; and identifying the textile soft goods contained in the vacuum-resealable bag by physically associating printed media with the retail packaging. The system further includes individually displaying, to consumers, the products for retail sale by setting out the products on store shelves; removing, by the consumers, the vacuum-resealable bags from the respective retail packaging and removing the textile soft goods thereof from the respective vacuum-resealable bags; and reusing, by the consumers, the vacuum-resealable bags by vacuum-packing items therein.

Additional aspects of the invention relate to a textile soft good product for retail sale in which the textile soft goods are bedding components that are vacuum packed within a reusable vacuum-sealable bag and, more particularly, bedding components that constitute a bedding set. Aspects of the invention further relate to systems and methods in which textile soft goods (e.g., bedding components constituting a bedding set) are compression-packed in reusable vacuum-sealable bags for retail sale.

Another aspect of the invention relates to a textile soft goods product for retail sale. An exemplary such product includes a vacuum-sealable bag having a one-way valve assembly in a bag wall thereof for evacuating air from an interior space defined by the vacuum-sealable bag, wherein the one-way valve assembly is configured to receive a vacuum source, whereby the air within the interior space may be evacuated using the vacuum source, and configured to prevent air from re-entering the bag upon disengagement of the vacuum source, and having a closure mechanism configured to seal a mouth of the vacuum-sealable bag in an airtight manner.

Furthermore, in this aspect of the invention, the product includes textile soft goods comprising a plurality of individual and compressible bedding components constituting a bedding set, wherein the textile soft goods are folded and arranged together within the interior space of the vacuum-sealable bag and are maintained in a compressed condition resulting from a pressure differential existing between a pressure in the interior space of the bag and a pressure exterior to the bag, wherein none of the bedding components are individually packaged, and wherein the mouth of the vacuum-sealable bag when fully open is configured for insertion of the textile soft goods into the interior space of the vacuum-sealable bag and configured for withdrawal of the textile soft goods from the interior space of the vacuum-sealable bag.

Still yet in this aspect, the product includes printed media identifying the textile soft goods contained in the vacuum-sealable bag as being a bedding set, the printed media being physically associated with the vacuum-sealable bag.

In a feature of this aspect of the invention, the vacuum-sealable bag is configured to be opened and then reclosed such that the vacuum-sealable bag is reusable for vacuum-packing using a vacuum source after the bedding set has been removed therefrom. In another feature, the vacuum source comprises a home vacuum cleaner appliance. In still another feature, the printed media further identifies the reusability of the vacuum-sealable bag.

In a further feature of this aspect of the invention, the printed media constitutes a bar code identifying the textile soft goods product for retail sale. In another feature, the printed media includes an identification of a size of bedding components of the bedding set. In another feature still, the vacuum source comprises a home vacuum cleaner appliance. In a further feature still, at least one of the bedding components is nested within a fold of another one of the bedding components. In another feature, the printed media advertises the textile soft goods contained in the vacuum-sealable bag as being a bedding set. In still another feature, the printed media itemizes the textile soft goods contained in the vacuum-sealable bag. In yet a further feature, the vacuum-sealable bag comprises walls formed from film having a thickness of eight (8) millimeters. In an additional feature, the vacuum-sealable bag comprises pliable and air impermeable walls. In still another feature, the vacuum-sealable bag comprises walls formed from bi-axial layers of polyethylene and nylon. In a further feature, the bedding components comprise a comforter, a bedskirt, two pillow shams, a fitted sheet, a flat sheet, and two pillowcases. In yet a further feature, at least a portion of the vacuum-sealable bag is transparent such that the contents of the vacuum-sealable bag are viewable therethrough.

In another feature of this aspect of the invention, the product includes a case in which the vacuum-sealable bag containing the textile soft goods is contained. In yet another feature, the case is configured to be opened and then reclosed such that the case is reusable after the vacuum-sealable bag containing the bedding set has been removed therefrom. In another feature still, the vacuum-sealable bag is configured to be opened and then reclosed such that the vacuum-sealable bag is reusable after the bedding set has been removed therefrom. In still another feature, the printed media further identifies the reusability of the vacuum-sealable bag. In another feature, the case comprises a carrying handle configured for transporting the case by hand. In still another feature, the case includes a generally rectangular profile with rounded corners. In yet another feature, the case comprises a closure mechanism by which the case is transitioned between an opened state and a closed state. In a further feature, the closure mechanism of the case comprises a zipper mechanism. In a further feature still, the closure mechanism of the case extends around three sides of the case and wherein the fourth side of the case comprises a hinge. Still in another feature, the printed media comprises an adhesive label that is attached to the case containing the vacuum-sealable bag.

In yet a further feature of this aspect of the invention, the case comprises a pocket, the pocket including a transparent panel through which contents of the pocket are viewable from an exterior of the case. In another feature the printed media comprises a rigid planar member that is retained within the pocket of the case. In another feature, the rigid planar member comprises a card insert. In further features, the case comprises a pocket, the pocket including opposing front and rear transparent panels through which contents of the pocket are viewable. In still more features, the printed media comprises a rigid planar member that is retained within the pocket of the case. In still further features, the case comprises a lid, the lid includes a pocket with the printed media retained therein, and the printed media is viewable from an exterior of the pocket. In yet another feature, the case defines an interior containment space that is entirely consumed by the vacuum-sealable bag contained therein. In a further feature still, the case does not include an airtight seal closing off the interior containment space in which the vacuum-sealable bag is contained. In another feature, a hoop strength of the case is sufficient to maintain the textile soft goods in the compressed condition within the vacuum-sealable bag upon equalization of the pressure in the interior space of the vacuum-sealable bag and a pressure exterior to the bag.

In still another feature of this aspect of the invention, at least a portion of the vacuum-sealable bag is transparent such that the contents of the vacuum-sealable bag are viewable therethrough, and at least a portion of the case is transparent such that the contents of the vacuum-sealable bag are further viewable therethrough. In another feature, both the vacuum-sealable bag and the case include corners, and wherein the corners of the vacuum-sealable bag are not viewable through the case. In a further feature, the case comprises opposed transparent panels including corners, and wherein the corners of the transparent panels include non-transparent components that cover the corners of the vacuum-sealable bag and that reinforce the case and contribute to the hoop strength of the case. In a further feature still, the vacuum-sealable bag and the case are configured such that at least a portion of one of the textile soft goods is viewable from an exterior of the case through both a transparent portion of the case and a transparent portion of the vacuum-sealable bag.

Another aspect of the invention relates to a textile soft goods product for retail sale. An exemplary such product includes a vacuum-sealable bag having a one-way valve assembly in a bag wall thereof for evacuating air from an interior space defined by the vacuum-sealable bag, wherein the one-way valve assembly is configured to receive a vacuum source, whereby the air within the interior space may be evacuated using the vacuum source, and is configured to prevent air from re-entering the bag upon disengagement of the vacuum source. The vacuum-sealable bag further having a closure mechanism configured to seal a mouth of the vacuum-sealable bag in an airtight manner

Furthermore, in this aspect of the invention, the product includes textile soft goods including a plurality of individual and compressible bedding components constituting a bedding set, wherein the textile soft goods are maintained in a compressed condition within the vacuum-sealable bag as a result of a pressure differential existing between a pressure in the interior space of the bag and a pressure exterior to the bag, and wherein the mouth of the vacuum-sealable bag when fully open is configured for insertion of the textile soft goods into the interior space of the vacuum-sealable bag and configured for withdrawal of the textile soft goods from the interior space of the vacuum-sealable bag.

Still yet in this aspect, the product includes a case in which the vacuum-sealable bag containing the textile soft goods is itself contained, wherein the case includes printed media that identifies the textile soft goods contained in the vacuum-sealable bag as being a bedding set.

In a feature of this aspect of the invention, the case comprises a carrying handle configured for transporting the case having the vacuum-sealable bag contained therein by hand. In another feature, the case includes a bar code identifying the textile soft goods product for retail sale. In a further feature, the printed media of the case includes a bar code identifying the textile soft goods product for retail sale. In yet another feature, the printed media of the case advertises the textile soft goods contained in the vacuum-sealable bag as being a bedding set. In a further feature still, the printed media of the case itemizes the textile soft goods contained in the vacuum-sealable bag.

In another feature of this aspect of the invention, the bedding components contained within the vacuum-sealable bag comprise a comforter, a bedskirt, two pillow shams, a fitted sheet, a flat sheet, and two pillowcases. In yet another feature, the printed media comprises a card insert which is retained within the pocket of the case. In other features the case comprises a lid, the lid including the pocket within which the card insert is retained, whereby a rear side of the card insert is not viewable from an exterior of the case when the lid is closed but is viewable when the lid is open, and a hoop strength of the case is sufficient to maintain the textile soft goods in the compressed condition within the vacuum-sealable bag upon equalization of the pressure in the interior space of the vacuum-sealable bag and a pressure exterior to the vacuum-sealable bag.

Another aspect of the invention relates to a textile goods product for retail sale. An exemplary such product includes the combination of an inner bag containing textile soft goods and an outer bag in which the inner bag itself is contained. The inner bag includes a vacuum-sealable bag (i) having a one-way valve assembly in a bag wall thereof for evacuating air from an interior space defined by the vacuum-sealable bag, wherein the one-way valve assembly is (A) configured to receive a vacuum source, whereby the air within the interior space may be evacuated using the vacuum source, and (B) configured to prevent air from re-entering the bag upon disengagement of the vacuum source, and (ii) having a closure mechanism configured to seal a mouth of the vacuum-sealable bag in an airtight manner. The outer bag defines an interior containment space that is entirely consumed by the inner bag contained therein. The textile soft goods comprise a plurality of individual and compressible bedding components constituting a bedding set, the textile soft goods being maintained in a compressed condition within the inner bag as a result of a pressure differential existing between a pressure in the interior space of the inner bag and an exterior pressure.

In a feature of this aspect of the invention, the exterior pressure is a pressure exterior to the outer bag. Alternatively, in another feature, the exterior pressure is a pressure exterior to the inner bag. In another feature, the outer bag is configured to be opened and then reclosed such that the outer bag is reusable after the inner bag containing the bedding set has been removed therefrom. In yet another feature, the inner bag is configured to be opened and then reclosed such that the inner bag is reusable for vacuum-packing after the bedding set has been removed therefrom. In a further feature, the printed media further identifies the reusability of the inner bag. In still a further feature, the outer bag includes printed media that constitutes a bar code identifying the textile soft goods product for retail sale. In a further feature still, the outer bag comprises a carrying handle configured for transporting the textile soft goods product by hand. In still another feature, the outer bag comprises a case having a generally rectangular profile with rounded corners.

In another feature of this aspect of the invention, the outer bag includes printed media that identifies the textile soft goods contained in the vacuum-sealable bag as being a bedding set. In yet another feature, a card insert is retained within the pocket of the case. In a further feature, the case comprises a lid, the lid including the pocket within which the card insert is retained, whereby a rear side of the card insert is not viewable when the lid is closed but is viewable when the lid is open.

Another aspect of the invention relates to a method of making a textile soft goods product for retail sale. An exemplary such method includes the steps of compressing textile soft goods including a plurality of individual and compressible bedding components constituting a bedding set within an interior space of a vacuum-sealable bag and maintaining the compressed textile soft goods in a compressed condition within the vacuum-sealable bag by maintaining a pressure differential between a pressure in the interior space of the bag and a pressure exterior to the bag, and identifying the textile soft goods contained in the vacuum-sealable bag as being a bedding set by physically associating printed media with the vacuum-sealable bag having the plurality of individual and compressible bedding components compressed therein. Such a vacuum-sealable bag includes a one-way valve assembly in a bag wall thereof for evacuating air from an interior space defined by the vacuum-sealable bag, the one-way valve assembly being (A) configured to receive a vacuum source, whereby the air within the interior space may be evacuated using the vacuum source, and (B) configured to prevent air from re-entering the bag upon disengagement of the vacuum source, and includes a closure mechanism configured to seal a mouth of the vacuum-sealable bag in an airtight manner.

In a feature of this aspect of the invention, a volume of space consumed collectively by the compressible bedding components is reduced by at least about 75% as a result of said compressing. In other features, the method further includes shipping the textile soft goods product to a wholesaler, retailer, distributor, or consumer. In a further feature, the vacuum-sealable bag is configured to be opened and then reclosed such that the vacuum-sealable bag is reusable by the consumer for vacuum-packing after the bedding set has been removed therefrom. In yet another feature, the method includes locating the vacuum-sealable bag having the plurality of individual and compressible bedding components compressed therein within a case. In a further feature, the vacuum-sealable bag and the case are configured such that at least a portion of one of the textile soft goods within the vacuum-sealable bag is viewable from an exterior of the case through both a transparent portion of the case and a transparent portion of the vacuum-sealable bag.

In another feature of this aspect of the invention, the case includes printed media that constitutes a bar code identifying the textile soft goods product for retail sale. In yet another feature, the case includes printed media that advertises the textile soft goods contained in the vacuum-sealable bag as being a bedding set. In a further feature still, the case includes printed media that itemizes the textile soft goods contained in the vacuum-sealable bag. In yet one more feature, the case comprises a lid, the lid including the pocket within which the card insert is retained, whereby a rear side of the card insert is not viewable from an exterior of the case when the lid is closed, but is viewable when the lid is open.

Another aspect of the invention relates to a method of making a textile soft goods product for retail sale. An exemplary such method includes packaging textile soft goods comprising a plurality of individual and compressible bedding components constituting a bedding set, wherein the textile soft goods are folded and arranged together within an interior space of a vacuum-sealable bag with none of the bedding components being individually packaged; maintaining the compressible bedding components in a compressed condition within the vacuum-sealable bag by maintaining a pressure differential between a pressure in the interior space of the bag and a pressure exterior to the bag, wherein the a vacuum-sealable bag (i) includes a one-way valve assembly in a bag wall thereof for evacuating air from an interior space defined by the vacuum-sealable bag, the one-way valve assembly being (A) configured to receive a vacuum source, whereby the air within the interior space may be evacuated using the vacuum source, and (B) configured to prevent air from re-entering the bag upon disengagement of the vacuum source, and (ii) includes a closure mechanism configured to seal a mouth of the vacuum-sealable bag in an airtight manner; and identifying the textile soft goods contained in the vacuum-sealable bag as being a bedding set by physically associating printed media with the vacuum-sealable bag having the plurality of individual and compressible bedding components packed therein.

In a feature of this aspect of the invention, the printed media comprises a bar code identifying the textile soft goods product for retail sale. In another feature of this aspect of the invention, the method includes locating the vacuum-sealable bag having the plurality of individual and compressible bedding components vacuum-packed therein within a case. In another feature, the case is configured to be opened and then reclosed such that the case is reusable for containing an item after the vacuum-sealable bag has been removed therefrom. In yet another feature, the case comprises a lid, the lid including the pocket with the printed media retained therein.

Another aspect of the invention relates to a method of making a textile soft goods product for retail sale. An exemplary such method includes folding and arranging textile soft goods within an interior space of a vacuum-sealable bag (i) having a one-way valve assembly in a bag wall thereof for evacuating air from an interior space defined by the vacuum-sealable bag, wherein the one-way valve assembly is (A) configured to receive a vacuum source, whereby the air within the interior space may be evacuated using the vacuum source, and (B) configured to prevent air from re-entering the bag upon disengagement of the vacuum source, and (ii) having a closure mechanism configured to seal a mouth of the vacuum-sealable bag in an airtight manner; containing the vacuum-sealable bag within an outer bag, the outer bag defining an interior containment space that is entirely consumed by the vacuum-sealable bag; and identifying the textile soft goods contained in the vacuum-sealable bag as being a bedding set by physically associating printed media with the outer bag.

In a feature of this aspect of the invention, the textile soft goods include a plurality of individual and compressible bedding components constituting a bedding set. In another feature, the method includes compression-packing the textile soft goods within the vacuum-sealable bag. In yet another feature, the method includes maintaining the textile soft goods in a compressed condition within the vacuum-sealable bag as a result of a pressure differential existing between a pressure in the interior space of the vacuum-sealable bag and an exterior pressure. In another feature, the exterior pressure comprises a pressure exterior to the outer bag. In yet another feature, the exterior pressure comprises a pressure exterior to the vacuum-sealable bag. In still another feature, the printed media of the outer bag advertises the textile soft goods contained in the vacuum-sealable bag as being a bedding set. In another feature, the printed media of the outer bag itemizes the textile soft goods contained in the vacuum-sealable bag. In still another feature, the printed media comprises an adhesive label that is attached to the outer bag containing the vacuum-sealable bag. In still a further feature, the outer bag comprises a pocket, the pocket including a transparent panel through which contents of the pocket are viewable from an exterior of the outer bag. In another feature, the printed media comprises a card insert which is retained within the pocket of the outer bag.

In another feature of this aspect of the invention, the outer bag comprises a pocket, the pocket including opposing front and rear transparent panels through which contents of the pocket are viewable. In another feature, the printed media comprises a card insert which is retained within the pocket of the outer bag. In still another feature, the outer bag comprises a lid, the lid including the pocket within which the card insert is retained, whereby a rear side of the card insert is not viewable from an exterior of the outer bag when the lid is closed but is viewable when the lid is open. In another feature, the outer bag defines an interior containment space that is entirely consumed by the vacuum-sealable bag contained therein. Still in another feature, the outer bag does not include an airtight seal closing off the interior containment space in which the vacuum-sealable bag is contained. In yet one more feature, a hoop strength of the outer bag is sufficient to maintain the textile soft goods in the compressed condition upon equalization of the pressure in the interior space of the vacuum-sealable bag and a pressure exterior to the bag. In another feature still, at least a portion of the vacuum-sealable bag is transparent such that the contents of the vacuum-sealable bag are viewable therethrough, and at least a portion of the outer bag is transparent such that the contents of the vacuum-sealable bag are further viewable therethrough. In another feature, the vacuum-sealable bag and the outer bag are configured such that at least a portion of one of the textile soft goods within the vacuum-sealable bag is viewable from an exterior of the outer bag through both a transparent portion of the outer bag and a transparent portion of the vacuum-sealable bag. In still another feature, both the vacuum-sealable bag and the outer bag include corners, and wherein the corners of the vacuum-sealable bag are not viewable through the outer bag. In one more feature, the outer bag comprises opposed transparent panels including corners, and wherein the corners of the transparent panels include non-transparent components that cover the corners of the vacuum-sealable bag and that reinforce the outer bag and contribute to the hoop strength of the outer bag.

Another aspect of the invention relates to a shipping package of bedding sets. An exemplary such shipping package includes a first textile soft goods product for retail sale comprising, a first vacuum-sealable bag (A) having a one-way valve assembly in a bag wall thereof for evacuating air from an interior space defined by the first vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the first vacuum-sealable bag in an airtight manner, a plurality of individual and compressible bedding components constituting a first bedding set for a first particular size of bed, the bedding components being maintained in a compressed condition within the first vacuum-sealable bag as a result of a first pressure differential existing between a first pressure in the interior space of the bag and a pressure exterior to the first vacuum-sealable bag, the first vacuum-sealable bag defining an interior containment space that is entirely consumed by the bedding components compressed therein, and a first case in which the first vacuum-sealable bag containing the first bedding set is itself contained, the first case defining an interior containment space that is entirely consumed by the first vacuum-sealable bag contained therein, the first case further including printed media that identifies the bedding set contained in the first vacuum-sealable bag as being a bedding set. The package further includes a second textile soft goods product for retail sale comprising, a second vacuum-sealable bag (A) having a one-way valve assembly in a bag wall thereof for evacuating air from an interior space defined by the second vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the second vacuum-sealable bag in an airtight manner, a plurality of individual and compressible bedding components constituting a second bedding set for a second particular size of bed, the bedding components being maintained in a compressed condition within the second vacuum-sealable bag as a result of a second pressure differential existing between a second pressure in the interior space of the bag and the pressure exterior to the second vacuum-sealable bag, the second vacuum-sealable bag defining an interior containment space that is entirely consumed by the bedding components compressed therein, and a second case in which the second vacuum-sealable bag containing the second bedding set is itself contained, the second case defining an interior containment space that is entirely consumed by the second vacuum-sealable bag contained therein, the second case further including printed media that identifies the bedding set contained in the second vacuum-sealable bag as being a bedding set. The package further includes a third textile soft goods product for retail sale comprising, a third vacuum-sealable bag (A) having a one-way valve assembly in a bag wall thereof for evacuating air from an interior space defined by the third vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the third vacuum-sealable bag in an airtight manner, a plurality of individual and compressible bedding components constituting a third bedding set for a third particular size of bed, the bedding components being maintained in a compressed condition within the third vacuum-sealable bag as a result of a third pressure differential existing between a third pressure in the interior space of the bag and the pressure exterior to the third vacuum-sealable bag, the third vacuum-sealable bag defining an interior containment space that is entirely consumed by the bedding components compressed therein, and a third case in which the third vacuum-sealable bag containing the third bedding set is itself contained, the third case defining an interior containment space that is entirely consumed by the third vacuum-sealable bag contained therein, the third case further including printed media that identifies the bedding set contained in the third vacuum-sealable bag as being a bedding set. The package further includes a fourth textile soft goods product for retail sale comprising, a fourth vacuum-sealable bag (A) having a one-way valve assembly in a bag wall thereof for evacuating air from an interior space defined by the fourth vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the fourth vacuum-sealable bag in an airtight manner, a plurality of individual and compressible bedding components constituting a fourth bedding set for a fourth particular size of bed, the bedding components being maintained in a compressed condition within the fourth vacuum-sealable bag as a result of a fourth pressure differential existing between a fourth pressure in the interior space of the bag and the pressure exterior to the fourth vacuum-sealable bag, the fourth vacuum-sealable bag defining an interior containment space that is entirely consumed by the bedding components compressed therein, and a fourth case in which the fourth vacuum-sealable bag containing the fourth bedding set is itself contained, the fourth case defining an interior containment space that is entirely consumed by the fourth vacuum-sealable bag contained therein, the fourth case further including printed media that identifies the bedding set contained in the fourth vacuum-sealable bag as being a bedding set. The interior containment space of each of the first, second, third and fourth cases is substantially the same as the other cases, but wherein at least one of the first, second, third and fourth particular sizes of beds respectively corresponding to the bedding sets differs from at least another of the first, second, third and fourth particular sizes of beds.

In a feature of this aspect of the invention the first, second, third and fourth cases each have the same volume and footprint. In another feature, the first, second, third and fourth cases are identical in size to each other. In a further feature, the first particular size of bed is a size of a twin bed. In yet another feature, the second particular size of bed is a size of a double bed and the second differential pressure is greater than the first differential pressure. In a further feature still, the third particular size of bed is a size of a queen bed and the third differential pressure is greater than the second differential pressure. In yet another feature, the fourth particular size of bed is a size of a king bed and the fourth differential pressure is greater than the third differential pressure. In yet another feature, the shipping package is a box, and wherein the first, second, third and fourth cases substantially consume the entire interior containment space of the box. In a further feature, the bedding components of the first vacuum-sealable bag are in a less compressed condition than that of the bedding components of the second vacuum-sealable bag. In another feature, the bedding components of the second vacuum-sealable bag are in a less compressed condition than that of the bedding components of the third vacuum-sealable bag. In yet another feature, the bedding components of the third vacuum-sealable bag are in a less compressed condition than that of the bedding components of the fourth vacuum-sealable bag.

In another feature of this aspect of the invention, each respective vacuum-sealable bag is configured to be opened and then reclosed such that the vacuum-sealable bag is reusable for vacuum-packing using a vacuum source after the bedding set has been removed therefrom. In another feature, each respective case is configured to be opened and then reclosed such that the case is reusable after the vacuum-sealable bag containing the bedding set has been removed therefrom. In a further feature, the vacuum-sealable bag of each respective case is configured to be opened and then reclosed such that the vacuum-sealable bag is reusable after the bedding set has been removed therefrom. In yet a further feature, each respective case comprises a carrying handle configured for transporting the case having the vacuum-sealable bag contained therein by hand. In a further feature still, each respective case includes a generally rectangular profile with rounded corners. In yet a further feature, each respective case comprises a closure mechanism by which the case is transitioned between an opened state and a closed state. In yet another feature, the closure mechanism of each respective case comprises a zipper mechanism. In yet an additional feature, the closure mechanism of each respective case extends around three sides of the case, and the fourth side of the case comprises a hinge.

In another feature of this aspect of the invention, each respective case includes a bar code identifying the shipping package of bedding sets. In yet another feature, the printed media of each respective case includes a bar code identifying the shipping package of bedding sets. In yet a further feature, the printed media of each respective case advertises the textile soft goods contained in the vacuum-sealable bag as being a bedding set. In yet one more feature, the printed media of each respective case itemizes the textile soft goods contained in the vacuum-sealable bag. In an additional feature, the bedding components contained within each respective vacuum-sealable bag comprise a comforter, a bedskirt, two pillow shams, a fitted sheet, a flat sheet, and two pillowcases. In a further feature, the printed media comprises an adhesive label that is attached to each respective case containing the vacuum-sealable bag. In still another feature, each respective vacuum-sealable bag comprises pliable and air impermeable walls. In one additional feature, respective case comprises a pocket, the pocket including a transparent panel through which contents of the pocket are viewable from an exterior of the case. In still another feature, each respective case comprises a pocket, the pocket including opposing front and rear transparent panels through which contents of the pocket are viewable.

In another feature of this aspect of the invention, each respective case does not include an airtight seal closing off the interior containment space in which the vacuum-sealable bag is contained. In another feature, a hoop strength of each respective case is sufficient to maintain the textile soft goods in the compressed condition within the vacuum-sealable bag upon equalization of the pressure in the interior space of the vacuum-sealable bag and a pressure exterior to the bag. In yet another feature, at least a portion of each respective vacuum-sealable bag is transparent such that the contents of the vacuum-sealable bag are viewable therethrough, and at least a portion of each respective case is transparent such that the contents of the respective vacuum-sealable bag are further viewable therethrough. In an additional feature, each vacuum-sealable bag and each case are configured such that at least a portion of one of the textile soft goods within each vacuum-sealable bag is viewable from an exterior of the respective case the bag is contained in through both a transparent portion of the case and a transparent portion of the vacuum-sealable bag. In a further feature still, each vacuum-sealable bag and each case include corners, and wherein the corners of each vacuum-sealable bag are not viewable through the respective case the bag is contained in. In another feature, each case comprises opposed transparent panels including corners, the corners of the transparent panels including non-transparent components that cover the corners of the respective vacuum-sealable bag contained therein, the non-transparent components reinforcing the case and contributing to the hoop strength of the case.

Another aspect of the invention relates to a shipping package of bedding sets. An exemplary such package includes a plurality of textile soft goods products for retail sale, each comprising, a vacuum-sealable bag (A) having a one-way valve assembly in a bag wall thereof for evacuating air from an interior space defined by the vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the vacuum-sealable bag in an airtight manner, a plurality of individual and compressible bedding components constituting a bedding set for a particular size of bed, the bedding components being maintained in a compressed condition within the vacuum-sealable bag as a result of a respective pressure differential existing between a pressure in the interior space of the bag and a pressure exterior to the vacuum-sealable bag, the vacuum-sealable bag defining an interior containment space that is entirely consumed by the bedding components compressed therein, and a case in which the vacuum-sealable bag containing the bedding set is itself contained, the case defining an interior containment space that is entirely consumed by the vacuum-sealable bag contained therein, the case further including printed media that identifies the bedding set contained in the vacuum-sealable bag as being a bedding set. Each respective case of the plurality of textile soft goods products for retail sale is substantially the same size and volume as each of the other cases of the plurality of textile soft goods products for retail sale, and wherein the shipping package comprises a box defining an interior containment space, the interior containment space being entirely consumed by the cases of the plurality of textile soft goods products for retail sale, but wherein at least one of the bedding sets is for a particular size of bed that is different than that of at least one of the other bedding sets.

Another aspect of the invention relates to a display of bedding sets for retail sale. An exemplary such display includes a first textile soft goods product for retail sale comprising, a first vacuum-sealable bag (A) having a one-way valve assembly in a bag wall thereof for evacuating air from an interior space defined by the first vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the first vacuum-sealable bag in an airtight manner, a plurality of individual and compressible bedding components constituting a first bedding set for a twin size bed, the bedding components being maintained in a compressed condition within the first vacuum-sealable bag as a result of a first pressure differential existing between a first pressure in the interior space of the bag and a pressure exterior to the first vacuum-sealable bag, the first vacuum-sealable bag defining an interior containment space that is entirely consumed by the bedding components compressed therein, and a first case in which the first vacuum-sealable bag containing the first bedding set is itself contained, the first case defining an interior containment space that is entirely consumed by the first vacuum-sealable bag contained therein, the first case further including printed media that identifies the bedding set contained in the first vacuum-sealable bag as being a bedding set for a twin size bed. An exemplary such display further includes a second textile soft goods product for retail sale comprising, a second vacuum-sealable bag (A) having a one-way valve assembly in a bag wall thereof for evacuating air from an interior space defined by the second vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the second vacuum-sealable bag in an airtight manner, a plurality of individual and compressible bedding components constituting a second bedding set for a full size bed, the bedding components being maintained in a compressed condition within the second vacuum-sealable bag as a result of a second pressure differential existing between a second pressure in the interior space of the bag and the pressure exterior to the second vacuum-sealable bag, the second vacuum-sealable bag defining an interior containment space that is entirely consumed by the bedding components compressed therein, and a second case in which the second vacuum-sealable bag containing the second bedding set is itself contained, the second case defining an interior containment space that is entirely consumed by the second vacuum-sealable bag contained therein, the second case further including printed media that identifies the bedding set contained in the second vacuum-sealable bag as being a bedding set for a full size bed. An exemplary such display further includes a third textile soft goods product for retail sale comprising, a third vacuum-sealable bag (A) having a one-way valve assembly in a bag wall thereof for evacuating air from an interior space defined by the third vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the third vacuum-sealable bag in an airtight manner, a plurality of individual and compressible bedding components constituting a third bedding set for a queen size bed, the bedding components being maintained in a compressed condition within the third vacuum-sealable bag as a result of a third pressure differential existing between a third pressure in the interior space of the bag and the pressure exterior to the third vacuum-sealable bag, the third vacuum-sealable bag defining an interior containment space that is entirely consumed by the bedding components compressed therein, and a third case in which the third vacuum-sealable bag containing the third bedding set is itself contained, the third case defining an interior containment space that is entirely consumed by the third vacuum-sealable bag contained therein, the third case further including printed media that identifies the bedding set contained in the third vacuum-sealable bag as being a bedding set for a queen size bed. An exemplary such display further includes a fourth textile soft goods product for retail sale comprising, a fourth vacuum-sealable bag (A) having a one-way valve assembly in a bag wall thereof for evacuating air from an interior space defined by the fourth vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the fourth vacuum-sealable bag in an airtight manner, a plurality of individual and compressible bedding components constituting a fourth bedding set for a king size bed, the bedding components being maintained in a compressed condition within the fourth vacuum-sealable bag as a result of a fourth pressure differential existing between a fourth pressure in the interior space of the bag and the pressure exterior to the fourth vacuum-sealable bag, the fourth vacuum-sealable bag defining an interior containment space that is entirely consumed by the bedding components compressed therein, and a fourth case in which the fourth vacuum-sealable bag containing the fourth bedding set is itself contained, the fourth case defining an interior containment space that is entirely consumed by the fourth vacuum-sealable bag contained therein, the fourth case further including printed media that identifies the bedding set contained in the fourth vacuum-sealable bag as being a bedding set for a king size bed. Each of the first, second, third, and fourth cases is displayed on a shelf of a retail store and the physical dimensions of each of the first, second, third and fourth cases is substantially the same as each of the other cases.

Another aspect of the invention relates to a display of bedding sets for retail sale. An exemplary such display includes a plurality of textile soft goods products for retail sale, each comprising, a vacuum-sealable bag (A) having a one-way valve assembly in a bag wall thereof for evacuating air from an interior space defined by the vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the vacuum-sealable bag in an airtight manner, a plurality of individual and compressible bedding components constituting a bedding set for a particular size of bed, the bedding components being maintained in a compressed condition within the vacuum-sealable bag as a result of a respective pressure differential existing between a pressure in the interior space of the bag and a pressure exterior to the vacuum-sealable bag, the vacuum-sealable bag defining an interior containment space that is entirely consumed by the bedding components compressed therein, and a case in which the vacuum-sealable bag containing the bedding set is itself contained, the case defining an interior containment space that is entirely consumed by the vacuum-sealable bag contained therein, the case further including printed media that identifies the bedding set contained in the vacuum-sealable bag as being a bedding set for the particular size of bed. Each of the plurality of textile soft goods products for retail sale is displayed on a shelf of a retail store. Each respective case of the plurality of textile soft goods products for retail sale is substantially the same size and volume as each of the other cases of the plurality of textile soft goods products for retail sale. At least one of the bedding sets is for a particular size of bed that is different than that of at least one of the other bedding sets.

Another aspect of the invention relates to a method of shipping bedding sets for retail sale. An exemplary such method includes making a first textile soft goods product for retail sale comprising, compression-packing textile soft goods comprising a plurality of individual and compressible bedding components constituting a bedding set for a first particular size of bed, wherein the textile soft goods are folded and arranged together within an interior space of a first vacuum-sealable bag with none of the bedding components being individually packaged, maintaining the compressible bedding components in a compressed condition within the first vacuum-sealable bag by maintaining a first pressure differential between a first pressure in the interior space of the bag and a pressure exterior to the bag, wherein the first vacuum-sealable bag (A) includes a one-way valve assembly in a bag wall thereof for evacuating air from an interior space defined by the first vacuum-sealable bag, the one-way valve assembly being (I) configured to receive a vacuum source, whereby the air within the interior space may be evacuated using the vacuum source, and (II) configured to prevent air from re-entering the bag upon disengagement of the vacuum source, and (B) includes a closure mechanism configured to seal a mouth of the first vacuum-sealable bag in an airtight manner, locating the first vacuum-sealable bag having the plurality of individual and compressible bedding components collectively packaged therein within a first case such that an interior containment space defined by the first case is entirely consumed by the first vacuum-sealable bag, and identifying the textile soft goods contained in the first vacuum-sealable bag as being a bedding set for the first particular size of bed by physically associating printed media with the first case.

The exemplary such method further includes making a second textile soft goods product for retail sale comprising, compression-packing textile soft goods comprising a plurality of individual and compressible bedding components constituting a bedding set for a second particular size of bed, wherein the textile soft goods are folded and arranged together within an interior space of a second vacuum-sealable bag with none of the bedding components being individually packaged, maintaining the compressible bedding components in a compressed condition within the second vacuum-sealable bag by maintaining a second pressure differential between a second pressure in the interior space of the bag and a pressure exterior to the bag, wherein the second vacuum-sealable bag (A) includes a one-way valve assembly in a bag wall thereof for evacuating air from an interior space defined by the second vacuum-sealable bag, the one-way valve assembly being (I) configured to receive a vacuum source, whereby the air within the interior space may be evacuated using the vacuum source, and (II) configured to prevent air from re-entering the bag upon disengagement of the vacuum source, and (B) includes a closure mechanism configured to seal a mouth of the second vacuum-sealable bag in an airtight manner, locating the second vacuum-sealable bag having the plurality of individual and compressible bedding components collectively packaged therein within a second case such that an interior containment space defined by the second case is entirely consumed by the second vacuum-sealable bag, and identifying the textile soft goods contained in the second vacuum-sealable bag as being a bedding set for the second particular size of bed by physically associating printed media with the second case.

The exemplary such method further includes making a third textile soft goods product for retail sale comprising, compression-packing textile soft goods comprising a plurality of individual and compressible bedding components constituting a bedding set for a third particular size of bed, wherein the textile soft goods are folded and arranged together within an interior space of a third vacuum-sealable bag with none of the bedding components being individually packaged, maintaining the compressible bedding components in a compressed condition within the third vacuum-sealable bag by maintaining a third pressure differential between a third pressure in the interior space of the bag and a pressure exterior to the bag, wherein the third vacuum-sealable bag (A) includes a one-way valve assembly in a bag wall thereof for evacuating air from an interior space defined by the third vacuum-sealable bag, the one-way valve assembly being (I) configured to receive a vacuum source, whereby the air within the interior space may be evacuated using the vacuum source, and (II) configured to prevent air from re-entering the bag upon disengagement of the vacuum source, and (B) includes a closure mechanism configured to seal a mouth of the third vacuum-sealable bag in an airtight manner, locating the third vacuum-sealable bag having the plurality of individual and compressible bedding components collectively packaged therein within a third case such that an interior containment space defined by the third case is entirely consumed by the third vacuum-sealable bag, and identifying the textile soft goods contained in the third vacuum-sealable bag as being a bedding set for the third particular size of bed by physically associating printed media with the third case.

The exemplary such method further includes making a fourth textile soft goods product for retail sale comprising, compression-packing textile soft goods comprising a plurality of individual and compressible bedding components constituting a bedding set for a fourth particular size of bed, wherein the textile soft goods are folded and arranged together within an interior space of a fourth vacuum-sealable bag with none of the bedding components being individually packaged, maintaining the compressible bedding components in a compressed condition within the fourth vacuum-sealable bag by maintaining a fourth pressure differential between a fourth pressure in the interior space of the bag and a pressure exterior to the bag, wherein the fourth vacuum-sealable bag (A) includes a one-way valve assembly in a bag wall thereof for evacuating air from an interior space defined by the fourth vacuum-sealable bag, the one-way valve assembly being (I) configured to receive a vacuum source, whereby the air within the interior space may be evacuated using the vacuum source, and (II) configured to prevent air from re-entering the bag upon disengagement of the vacuum source, and (B) includes a closure mechanism configured to seal a mouth of the fourth vacuum-sealable bag in an airtight manner, locating the fourth vacuum-sealable bag having the plurality of individual and compressible bedding components collectively packaged therein within a fourth case such that an interior containment space defined by the fourth case is entirely consumed by the fourth vacuum-sealable bag, and identifying the textile soft goods contained in the fourth vacuum-sealable bag as being a bedding set for the fourth particular size of bed by physically associating printed media with the fourth case.

The exemplary such method further includes packing the respective cases of the first, second, third and fourth textile soft goods products for retail sale in a shipping container such that the respective cases of the first, second, third and fourth textile soft goods product for retail sale collectively consume the entire interior containment space of the shipping container, wherein the interior containment space of each of the first, second, third and fourth cases is substantially the same as the other cases, but wherein at least one of the first, second, third and fourth particular sizes of beds respectively corresponding to the bedding sets differs from at least another of the first, second, third and fourth particular sizes of beds, and finally, shipping the packed shipping container to a retailer, wholesaler, distributor or consumer.

In a feature of this aspect of the invention, both each vacuum-sealable bag and each case include corners, and wherein the corners of each respective vacuum-sealable bag are not viewable through the corresponding respective case. In another feature, each case comprises opposed transparent panels including corners, and wherein the corners of the transparent panels include non-transparent components that cover the corners of the respective vacuum-sealable bag and that reinforce the case and contribute to the hoop strength of the case.

Another aspect of the invention relates to a method of shipping bedding sets for retail sale. An exemplary such method includes making a plurality of textile soft goods products for retail sale comprising, for each textile soft goods product, the steps of, compression-packing textile soft goods comprising a plurality of individual and compressible bedding components constituting a bedding set for a particular size of bed, wherein the textile soft goods are folded and arranged together within an interior space of a vacuum-sealable bag with none of the bedding components being individually packaged, maintaining the compressible bedding components in a compressed condition within the vacuum-sealable bag by maintaining a pressure differential between a pressure in the interior space of the bag and a pressure exterior to the bag, wherein the vacuum-sealable bag (A) includes a one-way valve assembly in a bag wall thereof for evacuating air from an interior space defined by the vacuum-sealable bag, the one-way valve assembly being (I) configured to receive a vacuum source, whereby the air within the interior space may be evacuated using the vacuum source, and (II) configured to prevent air from re-entering the bag upon disengagement of the vacuum source, and (B) includes a closure mechanism configured to seal a mouth of the vacuum-sealable bag in an airtight manner, locating the vacuum-sealable bag having the plurality of individual and compressible bedding components collectively packaged therein within a case such that an interior containment space defined by the case is entirely consumed by the vacuum-sealable bag, and identifying the textile soft goods contained in the vacuum-sealable bag as being a bedding set for the particular size of bed by physically associating printed media with the case. An exemplary such method further includes packing each respective case of the plurality in a shipping container such that the respective cases collectively consume the entire interior containment space of the shipping container, wherein each respective case of the plurality of textile soft goods products for retail sale is substantially the same size and volume as each of the other cases of the plurality of textile soft goods products for retail sale, but wherein at least one of the bedding sets of the cases is for a particular size of bed that is different than that of at least one of the other bedding sets of the cases. Finally, an exemplary such method includes shipping the packed shipping container to a retailer, wholesaler, distributor or consumer.

Another aspect of the invention relates to an environmentally friendly system in which product packaging is reused post purchase by consumers. An exemplary such system includes making textile soft goods products for retail sale comprising, for each textile soft goods product, the steps of, locating textile soft goods within an interior space of a vacuum-sealable bag (A) having a one-way valve assembly in a bag wall thereof for evacuating air from an interior space defined by the vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the vacuum-sealable bag in an airtight manner, locating the vacuum-sealable bag within an outer bag, and identifying the textile soft goods contained in the vacuum-sealable bag as being a bedding set by physically associating printed media with the outer bag. The vacuum-sealable bag is configured to be opened and then reclosed such that the vacuum-sealable bag is reusable for vacuum-packing using a vacuum source after the bedding set has been removed therefrom. An exemplary such system further includes advertising as a selling point to consumers the reusability of the vacuum-sealable bags of the textile soft goods products for retail sale.

A feature of this aspect of the invention includes a case. In another feature, the case defines an interior containment space that is entirely consumed by the reusable vacuum-sealable bag. In yet another feature, the case includes a carrying handle configured for transporting the case by hand. In yet a further feature, each bedding set is identified as including a comforter, a bedskirt, two pillow shams, a fitted sheet, a flat sheet, and two pillowcases.

Another aspect of this invention relates to an environmentally friendly system in which product packaging is reused post purchase by consumers. An exemplary such system includes purchasing bedding sets, each vacuum-packaged within a reusable vacuum-sealable bag (i) having a one-way valve assembly in a bag wall thereof for evacuating air from an interior space defined by the vacuum-sealable bag, wherein the one-way valve assembly is (A) configured to receive a vacuum source, whereby the air within the interior space may be evacuated using the vacuum source, and (B) configured to prevent air from re-entering the bag upon disengagement of the vacuum source, and (ii) having a closure mechanism configured to seal a mouth of the vacuum-sealable bag in an airtight manner, removing the bedding sets from the vacuum-sealable bags for use on beds, and reusing by the consumers the vacuum-sealable bags by vacuum-packing compressible items therein for storage thereof.

In a feature of this aspect of the invention, the step of vacuum-packing compressible items in the vacuum-sealable bags by the consumers is performed by attaching vacuum cleaners of the consumers to the one-way valves of the vacuum-sealable bags. In another feature, the vacuum-sealable bags are each packaged within an outer bag at the point-of-purchase, the outer bag including printed media identifying the textile soft goods contained in the vacuum-sealable bag as being a bedding set. In yet another feature, each outer bag defines an interior containment space that is entirely consumed by the reusable vacuum-sealable bag contained therein. In a further feature, each outer bag includes a carrying handle configured for transporting the case by hand. In yet another feature, each outer bag is a case that is configured to be opened and then reclosed such that the case is reusable after the vacuum-sealable bag containing the bedding set has been removed from the case. In yet a further feature, each case comprises a closure mechanism by which the case is transitioned between an opened state and a closed state. In still another feature, the closure mechanism of each case comprises a zipper mechanism. In another feature still, the closure mechanism of each case extends around three sides of the case and the fourth side of the case comprises a hinge. In still an additional feature, the system further includes reusing the cases by the consumers after removing the vacuum-sealable bags contained therein. In another feature, each bedding set comprises a comforter, a bedskirt, two pillow shams, a fitted sheet, a flat sheet, and two pillowcases.

Another aspect of this invention relates to an environmentally friendly system in which product packaging is reused post purchase by consumers. An exemplary such system includes making, by a manufacturer, textile soft goods comprising bedding sets for retail sale comprising, for each bedding set, the steps of, locating bedding components constituting the respective bedding set within an interior space of a vacuum-sealable bag (A) having a one-way valve assembly in a bag wall thereof for evacuating air from an interior space defined by the vacuum-sealable bag, wherein the one-way valve assembly is (I) configured to receive a vacuum source, whereby the air within the interior space may be evacuated using the vacuum source, and (II) configured to prevent air from re-entering the bag upon disengagement of the vacuum source, and (B) having a closure mechanism configured to seal a mouth of the vacuum-sealable bag in an airtight manner, locating the vacuum-sealable bag within an outer case, and identifying the textile soft goods contained in the vacuum-sealable bag as being a bedding set by physically associating printed media with the outer case. The vacuum-sealable bag is configured to be opened and then reclosed such that the vacuum-sealable bag is reusable for vacuum-packing using a vacuum source after the bedding set has been removed therefrom. An exemplary such system further includes individually displaying, to consumers, the bedding sets for retail sale by setting out the outer cases on store shelves, removing, by the consumers, the vacuum-sealable bags from the outer cases and removing the bedding sets thereof from the vacuum-sealable bags for use on beds, and reusing by the consumers the vacuum-sealable bags by vacuum-packing compressible items therein for storage thereof.

A feature of this aspect of the invention includes shipping the outer cases to retailers for displaying. In another feature, said shipping includes packing a plurality of outer cases within a shipping container such that an interior containment space of the shipping container is entirely consumed by the outer cases packed therein, wherein the outer cases have the same size and footprint, wherein each outer case defines an interior containment space that is entirely consumed by the vacuum-sealable bag contained therein, and wherein at least one of the outer cases in a respective shipping container contains a bedding set that is for a bed size that is different from a bed size of the another bedding set in at least one of the other outer cases in that shipping container.

In another feature of this aspect of the invention, the outer cases are unpacked from the shipping container by retailers and placed on store shelves without opening the outer cases. In another feature, each outer case includes a carrying handle configured for transporting the case by hand. In yet another feature, each outer case is a case that is configured to be opened and then reclosed such that the case is reusable after the vacuum-sealable bag containing the bedding set has been removed from the case. In still another feature, each case comprises a closure mechanism by which the case is transitioned between an opened state and a closed state. In another feature still, the closure mechanism of each case comprises a zipper mechanism. In yet another feature, the closure mechanism of each case extends around three sides of the case and the fourth side of the case comprises a hinge. An additional feature includes reusing the cases by the consumers after removing the vacuum-sealable bags contained therein. In a further feature, each bedding set comprises a comforter, a bedskirt, two pillow shams, a fitted sheet, a flat sheet, and two pillowcases.

In another aspect, a consumer textile soft goods product for retail sale includes: a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a closure mechanism configured to seal a mouth of the vacuum-sealable bag in an airtight manner; textile soft goods comprising a plurality of individual bedding components constituting a bedding set, wherein the textile soft goods are folded and arranged together within the interior space of the vacuum-sealable bag, and are maintained in a compressed condition resulting from a pressure differential existing between a pressure in the interior space of the vacuum-sealable bag and a pressure exterior to the vacuum-sealable bag, wherein none of the bedding components are individually packaged, and wherein the mouth of the vacuum-sealable bag when fully open is configured for insertion of the textile soft goods into the interior space of the vacuum-sealable bag, and is configured for withdrawal of the textile soft goods from the interior space of the vacuum-sealable bag; and printed media identifying the textile soft goods contained in the vacuum-sealable bag as being a bedding set, the printed media being physically associated with the vacuum-sealable bag. Preferably, the textile soft goods are vacuum-sealed within the vacuum-sealable bag, and a hoop strength of the case is sufficient to maintain the textile soft goods in a compressed condition within the vacuum-sealable bag upon equalization of the pressure in the interior space of the vacuum-sealable bag and a pressure exterior to the vacuum-sealable bag.

In a feature of this aspect, the vacuum-sealable bag is configured to be opened and then reclosed such that the vacuum-sealable bag is reusable by a consumer for vacuum-packing after the bedding set has been removed therefrom. The one-way valve assembly is located in a wall of the vacuum-sealable bag and is configured to receive a nozzle of a vacuum cleaner hose, whereby the air within the interior space may be evacuated using a vacuum cleaner. Alternatively, the one-way valve assembly of the vacuum-sealable bag is configured to expel air from the interior space thereof upon rolling up of the vacuum-sealable bag by a consumer for creating a pressure differential between a pressure in the interior space of the bag and a pressure exterior to the bag.

In another feature of this aspect, the product further includes retail packaging defining an interior space in which the vacuum-sealable bag containing the textile soft goods is contained. The retail packaging may be a case, a box, or an outer bag.

In another aspect of the invention, a consumer textile soft goods product for retail sale comprises: a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a closure mechanism configured to seal a mouth of the vacuum-sealable bag in an airtight manner; textile soft goods comprising a plurality of individual bedding components constituting a bedding set, wherein the textile soft goods are folded and arranged together within the interior space of the vacuum-sealable bag, and are maintained in a compressed condition resulting from a pressure differential existing between a pressure in the interior space of the bag and a pressure exterior to the bag, and wherein the mouth of the vacuum-sealable bag when fully open is configured for insertion of the textile soft goods into the interior space of the vacuum-sealable bag, and is configured for withdrawal of the textile soft goods from the interior space of the vacuum-sealable bag; and retail packaging in which the vacuum-sealable bag containing the textile soft goods is itself contained, the retail packaging including printed media that identifies the textile soft goods contained in the vacuum-sealable bag as being a bedding set.

In another aspect of the invention, a consumer textile soft goods product for retail sale comprises: a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a closure mechanism configured to seal a mouth of the vacuum-sealable bag in an airtight manner, wherein the vacuum-sealable bag is configured to be opened and then reclosed such that the vacuum-sealable bag is reusable for vacuum-packing by a consumer post retail sale; textile soft goods comprising a plurality of individual bedding components constituting a bedding set, wherein the textile soft goods are folded and arranged together within the interior space of the reusable vacuum-sealable bag, and are maintained in a compressed condition resulting from a pressure differential existing between a pressure in the interior space of the bag and a pressure exterior to the bag, and wherein the mouth of the reusable vacuum-sealable bag when fully open is configured for insertion of the textile soft goods into the interior space of the reusable vacuum-sealable bag, and is configured for withdrawal of the textile soft goods from the interior space of the reusable vacuum-sealable bag; and retail packaging in which the reusable vacuum-sealable bag containing the textile soft goods is itself contained, wherein the retail packaging does not include an airtight seal closing off the interior containment space in which the reusable vacuum-sealable bag is contained, and wherein a hoop strength of the retail packaging is sufficient to maintain the textile soft goods in a compressed condition within the reusable vacuum-sealable bag upon equalization of the pressure in the interior space of the reusable vacuum-sealable bag and a pressure exterior to the reusable vacuum-sealable bag.

In another aspect of the invention, a consumer textile soft goods product for retail sale, comprising: a vacuum-resealable bag having a one-way valve assembly configured such that air that is evacuated through the one-way valve assembly from an interior space defined by the vacuum-resealable bag is kept from reentering the vacuum-resealable bag through the one-way valve assembly, and a closure mechanism configured to seal a mouth of the vacuum-resealable bag in an airtight manner, wherein the vacuum-resealable bag is configured to be opened and then reclosed such that the vacuum-resealable bag is reusable for vacuum-packing; textile soft goods comprising a plurality of individual bedding components constituting a bedding set, wherein the textile soft goods are arranged together within the interior space of the vacuum-resealable bag and are maintained in a compressed condition resulting from a pressure differential existing between a pressure in the interior space of the vacuum-resealable bag and a pressure exterior to the vacuum-resealable bag, and wherein the mouth of the vacuum-resealable bag when fully open is configured for insertion of the textile soft goods into the interior space of the vacuum-resealable bag and configured for withdrawal of the textile soft goods from the interior space of the vacuum-resealable bag; and a case in which is contained the vacuum-resealable bag containing the textile soft goods, wherein the case comprises a pocket, the pocket including a transparent panel through which one or more contents of the pocket are viewable from an exterior of the case, wherein a rigid planar member comprising a card insert is retained within the pocket of the case and includes printed media identifying the textile soft goods contained in the vacuum-resealable bag as being a bedding set, wherein the case does not include an airtight seal closing off the interior containment space in which the vacuum-resealable bag is contained, and wherein a hoop strength of the case is sufficient to maintain the textile soft goods in a compressed condition within the vacuum-resealable bag upon equalization of the pressure in the interior space of the vacuum-resealable bag and a pressure exterior to the vacuum-resealable bag; wherein at least a portion of the vacuum-resealable bag is transparent such that one or more contents of the vacuum-resealable bag are viewable there through, and at least a portion of the case is transparent such that the one or more contents of the vacuum-resealable bag are further viewable there through, the vacuum-resealable bag being arranged within the case such that the one or more contents of the vacuum-resealable bag are viewable through both the case and the vacuum-resealable bag by a prospective customer at retail sale.

In accordance with yet another aspect of the invention, a consumer textile soft goods product for retail sale comprises the combination of an inner bag containing textile soft goods and an outer bag in which the inner bag itself is contained. The inner bag comprises a vacuum-sealable bag having a one-way valve assembly in a bag wall thereof for evacuating air from an interior space defined by the vacuum-sealable bag, the one-way valve assembly permitting air to be evacuated there through but preventing air from reentering there through, and a closure mechanism configured to seal a mouth of the vacuum-sealable bag in an airtight manner. The outer bag defines an interior containment space that is practically entirely consumed by the inner bag contained therein. The textile soft goods comprise a plurality of individual bedding components constituting a bedding set, the textile soft goods being maintained in a compressed condition within the inner bag as a result of a pressure differential existing between a pressure in the interior space of the inner bag and an exterior pressure.

In another aspect, a consumer textile soft goods product for retail sale comprises: an inner bag having a one-way valve assembly configured such that air, that is evacuated through the one-way valve assembly from an interior space defined by the inner bag, is kept from reentering the inner bag through the one-way valve assembly, and a closure mechanism configured to seal a mouth of the inner bag in an airtight manner, wherein the inner bag is configured to be opened and then reclosed such that the inner bag is reusable by a consumer post retail sale for vacuum-packing. The product further comprises textile soft goods comprising a plurality of individual bedding components, wherein the textile soft goods are folded and arranged together within the interior space of the inner bag and are maintained in a compressed condition resulting from a pressure differential existing between a pressure in the interior space of the inner bag and a pressure exterior to the inner bag, and wherein the mouth of the inner bag when fully open is configured for insertion of the textile soft goods into the interior space of the inner bag and configured for withdrawal of the textile soft goods from the interior space of the inner bag. The product also further comprises an outer bag in which the inner bag containing the textile soft goods is contained, wherein the outer bag does not include an airtight seal closing off the interior containment space in which the inner bag is contained, and wherein a hoop strength of the outer bag is sufficient to maintain the textile soft goods in a compressed condition within the inner bag upon equalization of the pressure in the interior space of the inner bag and a pressure exterior to the inner bag.

In accordance with an aspect of the invention, a method of packaging a consumer textile soft goods product for retail sale includes the steps of: compressing textile soft goods comprising a plurality of individual bedding components constituting a bedding set and maintaining the compressed textile soft goods in a compressed condition within an interior space of a vacuum-sealable bag by creating a pressure differential between a pressure in the interior space of the vacuum-sealable bag and a pressure exterior to the vacuum-sealable bag, wherein the vacuum-sealable bag includes a one-way valve assembly in a bag wall thereof configured for evacuating air through the one-way valve assembly from the interior space defined by the vacuum-sealable bag such that the evacuated air is kept from reentering the vacuum-sealable bag through the one-way valve assembly, and a closure mechanism configured to seal a mouth of the vacuum-sealable bag in an airtight manner; and identifying the textile soft goods contained in the vacuum-sealable bag as being a bedding set by physically associating printed media with the vacuum-sealable bag having the plurality of individual bedding components compressed therein.

In yet another aspect of the invention, a method of packaging a textile soft goods product for retail sale includes the steps of: compressing, by vacuum-packing, textile soft goods comprising a plurality of individual bedding components constituting a bedding set, wherein the textile soft goods are folded and arranged together within an interior space of a vacuum-sealable bag with none of the bedding components being individually packaged; maintaining the bedding components in a compressed condition within the vacuum-sealable bag by maintaining a pressure differential between a pressure in the interior space of the vacuum-sealable bag and a pressure exterior to the vacuum-sealable bag, wherein the vacuum-sealable bag includes a one-way valve assembly in a bag wall thereof for evacuating air through the one-way valve assembly from the interior space defined by the vacuum-sealable bag such that the evacuated air is kept from reentering the vacuum-sealable bag through the one-way valve assembly, and a closure mechanism configured to seal a mouth of the vacuum-sealable bag in an airtight manner; and locating the vacuum-sealable bag, itself having the plurality of individual bedding components contained therein, within retail packaging that identifies the textile soft goods contained in the vacuum-sealable bag as being a bedding set.

In another aspect, a method of packaging a textile soft goods product for retail sale includes the steps of: folding and arranging textile soft goods within an interior space of a vacuum-sealable bag, wherein the vacuum-sealable bag comprises pliable and air impermeable walls, a one-way valve assembly in one of the walls for evacuating air through the one-way valve assembly from the interior space defined by the vacuum-sealable bag such that the evacuated air is kept from reentering the vacuum-sealable bag through the one-way valve assembly, and a closure mechanism configured to seal a mouth of the vacuum-sealable bag in an airtight manner; containing the vacuum-sealable bag within an outer bag, the outer bag defining an interior containment space that is practically entirely consumed by the vacuum-sealable bag; and identifying the textile soft goods contained in the inner vacuum-sealable bag as being bedding components by physically associating printed media with the outer bag.

In yet another aspect of the invention, a method of packaging a textile soft goods product for retail sale includes the steps of: compressing the textile soft goods; arranging the compressed textile soft goods within an interior space of a vacuum-sealable bag, wherein the vacuum-sealable bag comprises pliable and air impermeable walls, a one-way valve assembly in one of the walls for evacuating air through the one-way valve assembly from the interior space defined by the vacuum-sealable bag such that the evacuated air is kept from reentering the vacuum-sealable bag through the one-way valve assembly, and a closure mechanism configured to seal a mouth of the vacuum-sealable bag in an airtight manner; vacuum-sealing the compressed textile soft goods within the interior space of the vacuum-sealable bag; containing the vacuum-sealable bag within an outer bag, the outer bag defining an interior containment space that is practically entirely consumed by the vacuum-sealable bag; and identifying the textile soft goods contained in the inner vacuum-sealable bag as being bedding components by physically associating printed media with the outer bag.

In another aspect, a method of packaging a textile soft goods product for retail sale includes the steps of: arranging textile soft goods within an interior space of a vacuum-sealable bag, wherein the vacuum-sealable bag comprises pliable and air impermeable walls, a one-way valve assembly in one of the walls for evacuating air through the one-way valve assembly from the interior space defined by the vacuum-sealable bag such that the evacuated air is kept from reentering the vacuum-sealable bag through the one-way valve assembly, and a closure mechanism configured to seal a mouth of the vacuum-sealable bag in an airtight manner; vacuum-sealing the compressed textile soft goods within the interior space of the vacuum-sealable bag such that the textile soft goods are compressed; containing the vacuum-sealable bag within an outer bag, the outer bag defining an interior containment space that is practically entirely consumed by the vacuum-sealable bag; and identifying the textile soft goods contained in the inner vacuum-sealable bag as being bedding components by physically associating printed media with the outer bag.

In accordance with another aspect of the invention, a shipping package of bedding sets comprises: a first textile soft goods product for retail sale comprising a first vacuum-sealable bag having a one-way valve assembly configured such that air, which is evacuated through the one-way valve assembly from an interior space defined by the first vacuum-sealable bag, is kept from reentering the first vacuum-sealable bag through the one-way valve assembly, and a closure mechanism configured to seal a mouth of the first vacuum-sealable bag in an airtight manner, textile soft goods comprising a plurality of individual bedding components constituting a first bedding set for a first particular size of bed, the textile soft goods being maintained in a compressed condition resulting from a first pressure differential existing between a first pressure in the interior space of the first vacuum-sealable bag and a pressure exterior to the first vacuum-sealable bag, the first vacuum-sealable bag defining an interior containment space that is practically entirely consumed by the bedding components maintained in a compressed condition therein, and first retail packaging in which the first vacuum-sealable bag containing the first bedding set is itself contained, the first retail packaging defining an interior containment space that is practically entirely consumed by the first vacuum-sealable bag contained therein, the first retail packaging further including printed media that identifies the bedding set contained in the first vacuum-sealable bag as being a bedding set; a second textile soft goods product for retail sale comprising a second vacuum-sealable bag having a one-way valve assembly configured such that air, which is evacuated through the one-way valve assembly from an interior space defined by the second vacuum-sealable bag, is kept from reentering the second vacuum-sealable bag through the one-way valve assembly, and a closure mechanism configured to seal a mouth of the second vacuum-sealable bag in an airtight manner, textile soft goods comprising a plurality of individual bedding components constituting a second bedding set for a second particular size of bed, the textile soft goods being maintained in a compressed condition resulting from a second pressure differential existing between a second pressure in the interior space of the second vacuum-sealable bag and a pressure exterior to the second vacuum-sealable bag, the second vacuum-sealable bag defining an interior containment space that is practically entirely consumed by the bedding components maintained in a compressed condition therein, and second retail packaging in which the second vacuum-sealable bag containing the second bedding set is itself contained, the second retail packaging defining an interior containment space that is practically entirely consumed by the second vacuum-sealable bag contained therein, the second retail packaging further including printed media that identifies the bedding set contained in the second vacuum-sealable bag as being a bedding set; a third textile soft goods product for retail sale comprising a third vacuum-sealable bag having a one-way valve assembly configured such that air, which is evacuated through the one-way valve assembly from an interior space defined by the third vacuum-sealable bag, is kept from reentering the third vacuum-sealable bag through the one-way valve assembly, and a closure mechanism configured to seal a mouth of the third vacuum-sealable bag in an airtight manner textile soft goods comprising a plurality of individual bedding components constituting a third bedding set for a third particular size of bed, the textile soft goods being maintained in a compressed condition resulting from a third pressure differential existing between a third pressure in the interior space of the third vacuum-sealable bag and a pressure exterior to the third vacuum-sealable bag, the third vacuum-sealable bag defining an interior containment space that is practically entirely consumed by the bedding components maintained in a compressed condition therein, and third retail packaging in which the third vacuum-sealable bag containing the third bedding set is itself contained, the third retail packaging defining an interior containment space that is practically entirely consumed by the third vacuum-sealable bag contained therein, the third retail packaging further including printed media that identifies the bedding set contained in the third vacuum-sealable bag as being a bedding set; and a fourth textile soft goods product for retail sale comprising a fourth vacuum-sealable bag having a one-way valve assembly configured such that air, which is evacuated through the one-way valve assembly from an interior space defined by the fourth vacuum-sealable bag, is kept from reentering the fourth vacuum-sealable bag through the one-way valve assembly, and a closure mechanism configured to seal a mouth of the fourth vacuum-sealable bag in an airtight manner, textile soft goods comprising a plurality of individual bedding components constituting a fourth bedding set for a fourth particular size of bed, the textile soft goods being maintained in a compressed condition resulting from a fourth pressure differential existing between a fourth pressure in the interior space of the fourth vacuum-sealable bag and a pressure exterior to the fourth vacuum-sealable bag, the fourth vacuum-sealable bag defining an interior containment space that is practically entirely consumed by the bedding components maintained in a compressed condition therein, and fourth retail packaging in which the fourth vacuum-sealable bag containing the fourth bedding set is itself contained, the fourth retail packaging defining an interior containment space that is practically entirely consumed by the fourth vacuum-sealable bag contained therein, the fourth retail packaging further including printed media that identifies the bedding set contained in the fourth vacuum-sealable bag as being a bedding set. The interior containment space of the retail packaging of each of the textile soft goods products for retail sale is substantially the same, but wherein the size of the bedding set of one of the textile soft goods products for retail sale differs from the size of the bedding set of another of the textile soft goods products for retail sale.

In accordance with another aspect of the invention, a shipping package of bedding sets includes: a plurality of textile soft goods products for retail sale, each comprising a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a reusable closure mechanism configured to seal a mouth of the vacuum-sealable bag in an airtight manner, textile soft goods comprising a plurality of individual bedding components constituting a bedding set for a particular size of bed, the textile soft goods being maintained in a compressed condition resulting from a pressure differential existing between a pressure in the interior space of the vacuum-sealable bag and a pressure exterior to the vacuum-sealable bag, the vacuum-sealable bag defining an interior containment space that is practically entirely consumed by the bedding components maintained in a compressed condition therein, and retail packaging in which the vacuum-sealable bag containing the bedding set is itself contained, the retail packaging defining an interior containment space that is practically entirely consumed by the vacuum-sealable bag contained therein, the retail packaging further including printed media that identifies the bedding set contained in the vacuum-sealable bag as being a bedding set. Each respective retail packaging of the plurality of textile soft goods products for retail sale is substantially the same size and volume as each other respective retail packaging of the plurality of textile soft goods products for retail sale, and wherein the shipping package comprises a box defining an interior containment space, the interior containment space being practically entirely consumed collectively by the retail packaging of each of the plurality of textile soft goods products for retail sale, but wherein at least one of the bedding sets is for a particular size of bed that is different than that of at least one of the other bedding sets.

In still yet another aspect of the invention, a shipping package of bedding sets comprises: a plurality of textile soft goods products for retail sale, each comprising a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a reusable closure mechanism configured to seal a mouth of the vacuum-sealable bag in an airtight manner, wherein the vacuum-sealable bag is configured to be opened and then reclosed such that the vacuum-sealable bag is reusable for vacuum-packing by a consumer after the bedding set has been removed therefrom, textile soft goods comprising a plurality of individual bedding components constituting a bedding set for a particular size of bed, the textile soft goods being maintained in a compressed condition resulting from a pressure differential existing between a pressure in the interior space of the vacuum-sealable bag and a pressure exterior to the vacuum-sealable bag, the vacuum-sealable bag defining an interior containment space that is practically entirely consumed by the bedding components maintained in a compressed condition therein, and retail packaging in which the vacuum-sealable bag containing the bedding set is itself contained, the retail packaging defining an interior containment space that is practically entirely consumed by the vacuum-sealable bag contained therein, the retail packaging further including printed media that identifies the bedding set contained in the vacuum-sealable bag as being a bedding set and the reusability of the vacuum-sealable bag contained therein; wherein each respective retail packaging of the plurality of textile soft goods products for retail sale is substantially the same size and volume as each other respective retail packaging of the plurality of textile soft goods products for retail sale, and wherein the shipping package comprises a box defining an interior containment space, the interior containment space being practically entirely consumed collectively by the retail packaging of each of the plurality of textile soft goods products for retail sale, but wherein at least one of the bedding sets is for a particular size of bed that is different than that of at least one of the other bedding sets.

In accordance with another aspect of the invention, a display of bedding sets for retail sale includes: a first textile soft goods product for retail sale comprising a first vacuum-sealable bag having a one-way valve assembly configured such that air, which is evacuated through the one-way valve assembly from an interior space defined by the first vacuum-sealable bag, is kept from reentering the first vacuum-sealable bag through the one-way valve assembly, and a closure mechanism configured to seal a mouth of the first vacuum-sealable bag in an airtight manner, textile soft goods comprising a plurality of individual bedding components constituting a first bedding set for a first particular size of bed, the textile soft goods being maintained in a compressed condition resulting from a first pressure differential existing between a first pressure in the interior space of the first vacuum-sealable bag and a pressure exterior to the first vacuum-sealable bag, the first vacuum-sealable bag defining an interior containment space that is practically entirely consumed by the bedding components maintained in a compressed condition therein, and first retail packaging in which the first vacuum-sealable bag containing the first bedding set is itself contained, the first retail packaging defining an interior containment space that is practically entirely consumed by the first vacuum-sealable bag contained therein, the first retail packaging further including printed media that identifies the bedding set contained in the first vacuum-sealable bag as being a bedding set; a second textile soft goods product for retail sale comprising a second vacuum-sealable bag having a one-way valve assembly configured such that air, which is evacuated through the one-way valve assembly from an interior space defined by the second vacuum-sealable bag, is kept from reentering the second vacuum-sealable bag through the one-way valve assembly, and a closure mechanism configured to seal a mouth of the second vacuum-sealable bag in an airtight manner, textile soft goods comprising a plurality of individual bedding components constituting a second bedding set for a second particular size of bed, the textile soft goods being maintained in a compressed condition resulting from a second pressure differential existing between a second pressure in the interior space of the second vacuum-sealable bag and a pressure exterior to the second vacuum-sealable bag, the second vacuum-sealable bag defining an interior containment space that is practically entirely consumed by the bedding components maintained in a compressed condition therein, and second retail packaging in which the second vacuum-sealable bag containing the second bedding set is itself contained, the second retail packaging defining an interior containment space that is practically entirely consumed by the second vacuum-sealable bag contained therein, the second retail packaging further including printed media that identifies the bedding set contained in the second vacuum-sealable bag as being a bedding set; a third textile soft goods product for retail sale comprising a third vacuum-sealable bag having a one-way valve assembly configured such that air, which is evacuated through the one-way valve assembly from an interior space defined by the third vacuum-sealable bag, is kept from reentering the third vacuum-sealable bag through the one-way valve assembly, and a closure mechanism configured to seal a mouth of the third vacuum-sealable bag in an airtight manner, textile soft goods comprising a plurality of individual bedding components constituting a third bedding set for a third particular size of bed, the textile soft goods being maintained in a compressed condition resulting from a third pressure differential existing between a third pressure in the interior space of the third vacuum-sealable bag and a pressure exterior to the third vacuum-sealable bag, the third vacuum-sealable bag defining an interior containment space that is practically entirely consumed by the bedding components maintained in a compressed condition therein, and third retail packaging in which the third vacuum-sealable bag containing the third bedding set is itself contained, the third retail packaging defining an interior containment space that is practically entirely consumed by the third vacuum-sealable bag contained therein, the third retail packaging further including printed media that identifies the bedding set contained in the third vacuum-sealable bag as being a bedding set; and a fourth textile soft goods product for retail sale comprising a fourth vacuum-sealable bag having a one-way valve assembly configured such that air, which is evacuated through the one-way valve assembly from an interior space defined by the fourth vacuum-sealable bag, is kept from reentering the fourth vacuum-sealable bag through the one-way valve assembly, and a closure mechanism configured to seal a mouth of the fourth vacuum-sealable bag in an airtight manner, textile soft goods comprising a plurality of individual bedding components constituting a fourth bedding set for a fourth particular size of bed, the textile soft goods being maintained in a compressed condition resulting from a fourth pressure differential existing between a fourth pressure in the interior space of the fourth vacuum-sealable bag and a pressure exterior to the fourth vacuum-sealable bag, the fourth vacuum-sealable bag defining an interior containment space that is practically entirely consumed by the bedding components maintained in a compressed condition therein, and fourth retail packaging in which the fourth vacuum-sealable bag containing the fourth bedding set is itself contained, the fourth retail packaging defining an interior containment space that is practically entirely consumed by the fourth vacuum-sealable bag contained therein, the fourth retail packaging further including printed media that identifies the bedding set contained in the fourth vacuum-sealable bag as being a bedding set. Each of the first retail packaging, the second retail packaging, the third retail packaging, and the fourth retail packaging is displayed on a shelf of a retail store; and the physical dimensions of the first retail packaging are substantially the same as the physical dimensions of each of the second retail packaging, the third retail packaging, and the fourth retail packaging.

In accordance with another aspect, a display of bedding sets for retail sale comprises: a plurality of textile soft goods products for retail sale, each comprising a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a closure mechanism configured to seal a mouth of the vacuum-sealable bag in an airtight manner, textile soft goods comprising a plurality of individual bedding components constituting a bedding set for a particular size of bed, the textile soft goods being maintained in a compressed condition resulting from a pressure differential existing between a pressure in the interior space of the vacuum-sealable bag and a pressure exterior to the vacuum-sealable bag, the vacuum-sealable bag defining an interior containment space in which the bedding components are maintained in a compressed condition therein, and retail packaging in which the vacuum-sealable bag containing the bedding set is itself contained, the retail packaging including printed media that identifies the bedding set contained in the vacuum-sealable bag as being a bedding set. The retail packaging of each one of the products is displayed on a shelf of a retail store; the retail packaging of each one of the products substantially consumes the same amount of retail shelf space; and the retail packaging of at least one of the products identifies a particular size of bed that differs from a particular size of bed identified by the retail packaging of another one of the products.

In accordance with another aspect, a display of bedding sets for retail sale includes: a plurality of textile soft goods products for retail sale, each comprising a vacuum-sealable bag having a one-way valve assembly configured such that air, which is evacuated through the one-way valve assembly from an interior space defined by the vacuum-sealable bag, is kept from reentering the vacuum-sealable bag through the one-way valve assembly, and a closure mechanism configured to seal a mouth of the vacuum-sealable bag in an airtight manner, wherein the vacuum-sealable bag is configured to be opened and then reclosed such that the vacuum-sealable bag is reusable for vacuum-packing by a consumer after the bedding set has been removed therefrom, textile soft goods comprising a plurality of individual bedding components constituting a bedding set for a particular size of bed, the textile soft goods being maintained in a compressed condition resulting from a pressure differential existing between a pressure in the interior space of the vacuum-sealable bag and a pressure exterior to the vacuum-sealable bag, the vacuum-sealable bag defining an interior containment space that is practically entirely consumed by the bedding components maintained in a compressed condition therein, and retail packaging in which the vacuum-sealable bag containing the bedding set is itself contained, the retail packaging defining an interior containment space that is practically entirely consumed by the vacuum-sealable bag contained therein, the retail packaging further including printed media that identifies the bedding set contained in the vacuum-sealable bag as being a bedding set and the reusability of the vacuum-sealable bag contained therein. The retail packaging of each of the products is displayed on a shelf of a retail store; and the physical dimensions of the retail packaging of each of the products is substantially the same, but wherein at least one of the products includes a bedding set for a particular size of bed that is different than the size of bed of the bedding set of another one of the products.

In another aspect, a method of shipping bedding sets for retail sale comprises the steps of: making a first textile soft goods product for retail sale comprising, vacuum-packing, within an interior space of a first vacuum-sealable bag, textile soft goods comprising a plurality of individual bedding components constituting a bedding set for a first particular size of bed, maintaining the bedding components in a compressed condition within the first vacuum-sealable bag by maintaining a first pressure differential between a first pressure in the interior space of the bag and a pressure exterior to the bag, wherein the first vacuum-sealable bag includes a one-way valve assembly configured such that air, which is evacuated through the one-way valve assembly from an interior space defined by the first vacuum-sealable bag, is kept from reentering the first vacuum-sealable bag through the one-way valve assembly, and a closure mechanism configured to seal a mouth of the first vacuum-sealable bag in an airtight manner, locating the first vacuum-sealable bag having the plurality of individual bedding components collectively packaged therein within a first retail packaging such that an interior containment space defined by the first retail packaging is practically entirely consumed by the first vacuum-sealable bag, and identifying the textile soft goods contained in the first vacuum-sealable bag as being a bedding set for the first particular size of bed by physically associating printed media with the first retail packaging; making a second textile soft goods product for retail sale comprising vacuum-packing, within an interior space of a second vacuum-sealable bag, textile soft goods comprising a plurality of individual bedding components constituting a bedding set for a second particular size of bed, maintaining the bedding components in a compressed condition within the second vacuum-sealable bag by maintaining a second pressure differential between a second pressure in the interior space of the bag and a pressure exterior to the bag, wherein the second vacuum-sealable bag includes a one-way valve assembly configured such that air, which is evacuated through the one-way valve assembly from an interior space defined by the second vacuum-sealable bag, is kept from reentering the second vacuum-sealable bag through the one-way valve assembly, and a closure mechanism configured to seal a mouth of the second vacuum-sealable bag in an airtight manner, locating the second vacuum-sealable bag having the plurality of individual bedding components collectively packaged therein within a second retail packaging such that an interior containment space defined by the second retail packaging is practically entirely consumed by the second vacuum-sealable bag, and identifying the textile soft goods contained in the second vacuum-sealable bag as being a bedding set for the second particular size of bed by physically associating printed media with the second retail packaging; making a third textile soft goods product for retail sale comprising vacuum-packing, within an interior space of a third vacuum-sealable bag, textile soft goods comprising a plurality of individual bedding components constituting a bedding set for a third particular size of bed, maintaining the bedding components in a compressed condition within the third vacuum-sealable bag by maintaining a third pressure differential between a third pressure in the interior space of the bag and a pressure exterior to the bag, wherein the third vacuum-sealable bag includes a one-way valve assembly configured such that air, which is evacuated through the one-way valve assembly from an interior space defined by the third vacuum-sealable bag, is kept from reentering the third vacuum-sealable bag through the one-way valve assembly, and a closure mechanism configured to seal a mouth of the third vacuum-sealable bag in an airtight manner, locating the third vacuum-sealable bag having the plurality of individual bedding components collectively packaged therein within a third retail packaging such that an interior containment space defined by the third retail packaging is practically entirely consumed by the third vacuum-sealable bag, and identifying the textile soft goods contained in the third vacuum-sealable bag as being a bedding set for the third particular size of bed by physically associating printed media with the third retail packaging; making a fourth textile soft goods product for retail sale comprising vacuum-packing, within an interior space of a fourth vacuum-sealable bag, textile soft goods comprising a plurality of individual bedding components constituting a bedding set for a fourth particular size of bed, maintaining the bedding components in a compressed condition within the fourth vacuum-sealable bag by maintaining a fourth pressure differential between a fourth pressure in the interior space of the bag and a pressure exterior to the bag, wherein the fourth vacuum-sealable bag includes a one-way valve assembly configured such that air, which is evacuated through the one-way valve assembly from an interior space defined by the fourth vacuum-sealable bag, is kept from reentering the fourth vacuum-sealable bag through the one-way valve assembly, and a closure mechanism configured to seal a mouth of the fourth vacuum-sealable bag in an airtight manner, locating the fourth vacuum-sealable bag having the plurality of individual bedding components collectively packaged therein within a fourth retail packaging such that an interior containment space defined by the fourth retail packaging is practically entirely consumed by the fourth vacuum-sealable bag, and identifying the textile soft goods contained in the fourth vacuum-sealable bag as being a bedding set for the fourth particular size of bed by physically associating printed media with the fourth retail packaging; and packing the respective first, second, third and fourth textile soft goods products for retail sale in a shipping container such that the respective retail packaging of the textile soft goods products for retail sale collectively consume the entire interior containment space of the shipping container, wherein the interior containment space of the retail packaging of each textile soft goods product for retail sale is substantially the same, but wherein at least some of the particular bed sizes differ from another one; and shipping the packed shipping container to a retailer, wholesaler, distributor or consumer.

In another aspect, a method of shipping bedding sets for retail sale comprises: making a plurality of textile soft goods products for retail sale comprising, for each textile soft goods product, the steps of vacuum-packing textile soft goods comprising a plurality of individual bedding components constituting a bedding set for a particular size of bed, wherein the textile soft goods are arranged together within an interior space of a vacuum-sealable bag, maintaining the bedding components in a compressed condition within the vacuum-sealable bag by maintaining a pressure differential between a pressure in the interior space of the bag and a pressure exterior to the bag, wherein the vacuum-sealable bag includes a one-way valve assembly configured such that air, which is evacuated through the one-way valve assembly from an interior space defined by the vacuum-sealable bag, is kept from reentering the vacuum-sealable bag through the one-way valve assembly, and a reusable closure mechanism configured to seal a mouth of the vacuum-sealable bag in an airtight manner, locating the vacuum-sealable bag having the plurality of individual bedding components collectively packaged therein within an interior containment space of retail packaging, and identifying the textile soft goods contained in the vacuum-sealable bag as being a bedding set for the particular size of bed by physically associating printed media with the retail packaging; packing each of the textile soft goods products in a shipping container such that the products collectively consume the entire interior containment space of the shipping container, wherein the retail packaging of each of the textile soft goods products for retail sale has substantially the same dimensions, but wherein at least one of the bedding sets of the products is for a particular bed size that is different than at least one of the bedding sets of another one of the products; and shipping the packed shipping container to a retailer, wholesaler, distributor or consumer.

In accordance with another aspect, an environmentally friendly system in which product packaging is reused post purchase by consumers includes: packaging textile soft goods products for retail sale comprising, for each textile soft goods product, the steps of, locating textile soft goods within an interior space of a vacuum-resealable bag, locating the vacuum-resealable bag within retail packaging, and identifying the textile soft goods contained in the vacuum-resealable bag by physically associating printed media with the retail packaging, wherein the vacuum-resealable bag is configured to be opened and then reclosed such that the vacuum-resealable bag is reusable for vacuum-packing by a consumer after the textile soft goods have been removed therefrom post purchase; and advertising as a selling point to consumers the reusability of the vacuum-resealable bags of the textile soft goods products for retail sale.

In another aspect, an environmentally friendly system in which product packaging is reused post purchase by consumers comprises: purchasing textile soft goods products, each including textile soft goods collectively packaged within a reusable vacuum-resealable bag; removing the textile soft goods from the vacuum-resealable bags for use; and reusing, by the consumers, the vacuum-resealable bags by vacuum-packing items therein.

In a still yet another aspect, an environmentally friendly system in which product packaging is reused post purchase by consumers, includes: packaging textile soft goods products for retail sale comprising, for each product, the steps of locating the textile soft goods within an interior space of a vacuum-resealable bag, locating the vacuum-resealable bag within retail packaging, and identifying the textile soft goods contained in the vacuum-resealable bag by physically associating printed media with the retail packaging; wherein the vacuum-resealable bag is configured to be opened and then reclosed such that the vacuum-resealable bag is reusable for vacuum-packing after the textile soft goods have been removed therefrom; individually displaying, to consumers, the products for retail sale by setting out the products on store shelves; removing, by the consumers, the vacuum-resealable bags from the respective retail packaging and removing the textile soft goods thereof from the respective vacuum-resealable bags; and reusing, by the consumers, the vacuum-resealable bags by vacuum-packing items therein.

In addition to the aforementioned aspects and features of the invention, it should be noted that the invention further encompasses the various possible combinations and subcombinations of such aspects and features, including those of any priority document incorporated herein by reference, including those of any priority document incorporated herein by reference. Thus, for example, any aspect may be combined with an aforementioned feature in accordance with the invention without requiring any other aspect or feature.

### BRIEF DESCRIPTION OF THE DRAWINGS

One or more preferred embodiments in accordance with one or more aspects of the invention now will be described in detail with reference to the accompanying drawings.

FIGS. 1A-1D illustrate a known method of compressing a textile soft good in a commercially available reusable vacuum-resealable bag.

FIG. 2 illustrates the use of a vacuum cleaner to evacuate air from a commercially available reusable vacuum-resealable bag.

FIG. 3 illustrates the positioning of a compressed reusable vacuum-resealable bag containing textile soft goods within a case of preferred embodiments in accordance with one or more aspects of the invention.

FIG. 4 illustrates the storage case of FIG. 3 after a lid of the case has been closed and a closure mechanism of the case has been engaged to retain the case in the closed position.

FIG. 5 is a front perspective view of an embodiment of a case of preferred embodiments in accordance with one or more aspects of the invention.

FIG. 6 is a rear perspective view of the case of FIG. 5.

FIG. 7A is a front perspective view of the case and FIG. 7B is a front perspective view of another preferred embodiment of a case in accordance with one or more aspects of the invention for comparison with that of FIG. 7A.

FIG. 8 illustrates packaging systems, methods, and apparatus of preferred embodiments in accordance with one or more aspects of the invention.

FIGS. 9A-9B are schematic illustrations of components of a case of preferred embodiments in accordance with one or more aspects of the invention.

FIG. 10 illustrates an exemplary card insert of preferred embodiments in accordance with one or more aspects of the invention.

FIG. 11 is a front perspective view of a case of preferred embodiments in accordance with one or more aspects of the invention.

FIG. 12 is a front plan view of the case of FIG. 11.

FIG. 13 is a rear plan view of the case of FIG. 11.

FIG. 14 is a top plan view of the case of FIG. 11.

FIG. 15 is a side plan view of the case of FIG. 11.

FIGS. 16A-16C illustrates features of a case of preferred embodiments in accordance with one or more aspects of the invention.

FIGS. 17-21 illustrate another case of preferred embodiments in accordance with one or more aspects of the invention.

FIGS. 22-28 illustrate retail packaging comprising a box of preferred embodiments in accordance with one or more aspects of the invention.

FIGS. 29-31 illustrate retail packaging comprising another box of preferred embodiments in accordance with one or more aspects of the invention.

FIG. 32 illustrates a system representative of one or more inventive business models in accordance with one or more aspects of the invention.

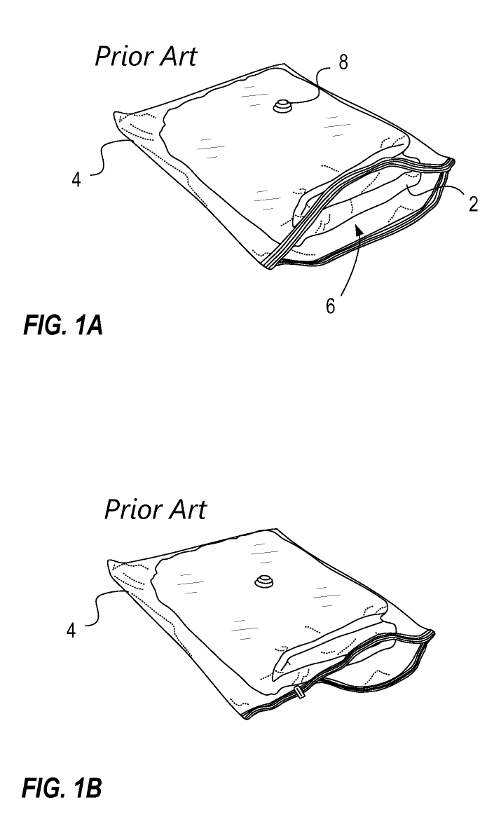

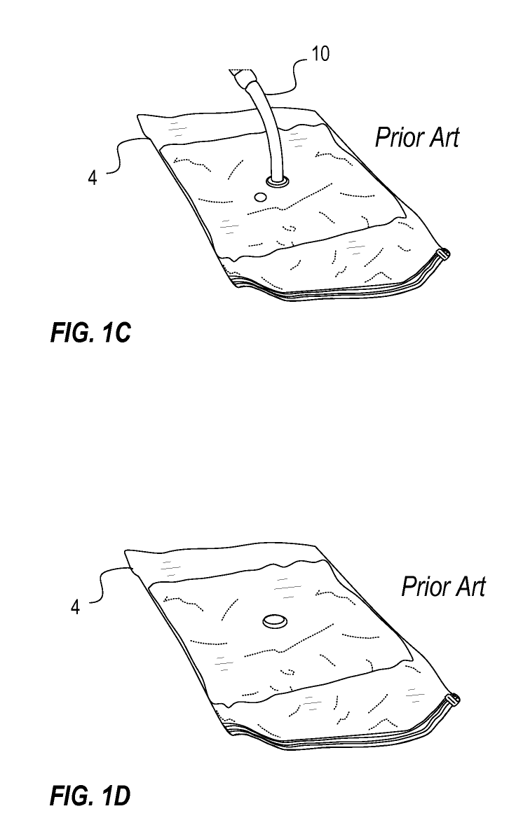

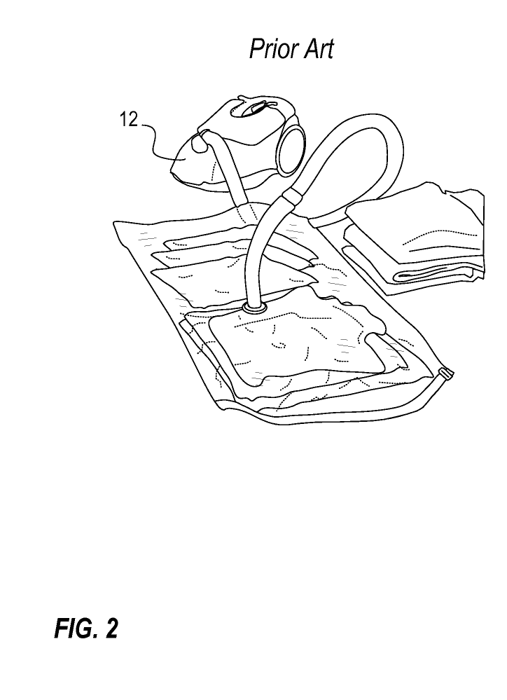

### DETAILED DESCRIPTION

As a preliminary matter, it will readily be understood by one having ordinary skill in the relevant art (“Ordinary Artisan”) that many of the aspects and features of the invention have broad utility and application. Furthermore, any embodiment discussed and identified as being “preferred” is considered to be part of a best mode contemplated for practicing one or more aspects and features of the invention. Other embodiments also may be discussed for additional illustrative purposes in providing a full and enabling disclosure of aspects and features of the invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and are considered to be within the disclosure of the many aspects and features of the invention.

Accordingly, while aspects and features of the invention are described herein in detail in relation to one or more embodiments, it is to be understood that this disclosure is illustrative and exemplary of such aspects and features of the invention, and are made merely for the purposes of providing a full and enabling disclosure. The detailed disclosure herein of one or more embodiments is not intended, nor is to be construed, to limit the scope of any patent protection, which scope is to be defined by the claims and the equivalents thereof. It is not intended that the scope of patent protection be defined by reading into any claim a limitation found herein that does not explicitly appear in the claim itself. Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders within the scope of the disclosure set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6 in the United States, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments are next described.

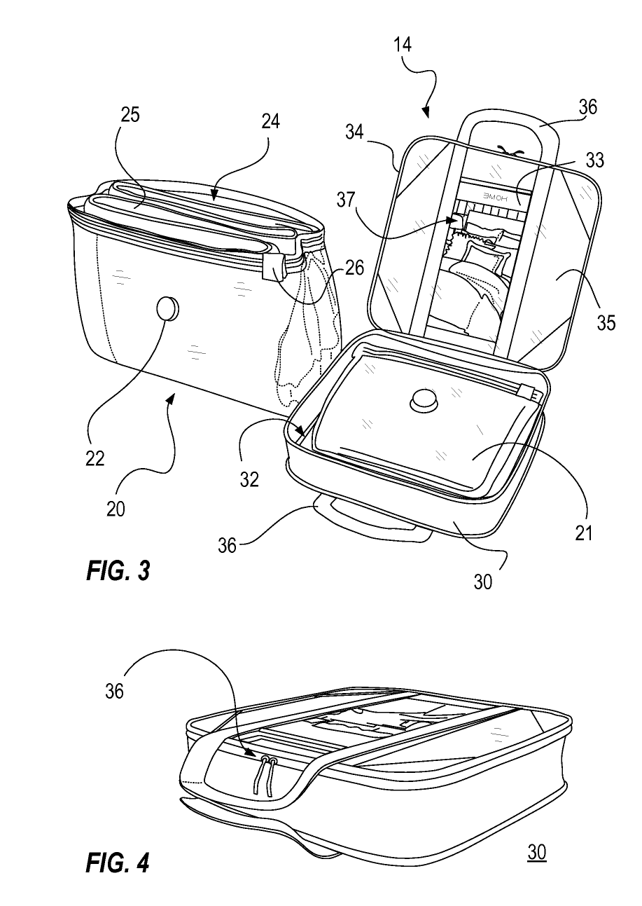

Starting with FIG. 3, a preferred consumer textile soft goods product 14 for retail sale to a consumer is illustrated.

More specifically, a preferred vacuum-sealable bag 20 is shown on the left in FIG. 3. The vacuum-sealable bag 20 preferably is reusable by a consumer for vacuum-packing after contents therein that were sold within the bag at retail have been removed by the consumer. The vacuum-sealable bag 20 includes pliable and air impermeable walls with a one-way valve assembly 22 located in one of the walls. The one-way valve assembly 22 is configured such that air, which is evacuated through the one-way valve assembly 22 from an interior space defined by the vacuum-sealable bag 20, is kept from reentering the vacuum-sealable bag 20 through the one-way valve assembly 22. The one-way valve assembly 22 also is configured to receive a nozzle of a vacuum cleaner hose, whereby the air within the interior space may be evacuated using a vacuum cleaner. The vacuum-sealable bag further has a closure mechanism 26 configured to seal a mouth 24 of the vacuum-sealable bag in an airtight manner.

In an alternative to the vacuum-sealable bag 20, a preferred vacuum-sealable bag may include, in lieu of the one-way air valve located in the bag wall and configured to receive a nozzle of a vacuum cleaner, a one-way air valve that is located with the closure mechanism and is configured to expel air from the interior space thereof upon rolling up of the vacuum-sealable bag by a consumer. Rolling up of the vacuum-sealable bag expels air from the interior space and creates a pressure differential between a pressure in the interior space of the bag and a pressure exterior to the bag.

It is believed that commercially available vacuum-resealable bags may be used in accordance with one or more aspects of the invention according to the foregoing descriptions, and that such commercially available vacuum-resealable bags include those currently sold under the SPACEBAG trademark by Illinois Tool Works and/or its affiliates. Moreover, such bags are disclosed or represented in the following patent references, each of which is incorporated herein by reference: U.S. Pat. No. 6,814,491; U.S. Pat. No. 7,055,794; and U.S. Patent Appl. Publication No. 2008/0118190.

As illustrated in FIG. 3, one or more textile soft goods 25 are shown folded and arranged within the vacuum-sealable bag 20. Such textile soft goods in some preferred embodiments comprise bedding components that make up or constitute a bedding set and include, for example, a comforter, a bedskirt, one or more pillow shams, a fitted sheet, a flat sheet, and one or more pillowcases. Some bedding components may be nested within other bedding components. Preferably, none of the bedding components are individually packaged, although in some variants one or more of the bedding components may be separately packaged. For instance, a sheet set or any component thereof may be individually packaged. The mouth 24 of the vacuum-sealable bag 20, when fully open, is configured for insertion of the textile soft goods 25 into the interior space of the vacuum-sealable bag 20, and is configured for withdrawal of the textile soft goods 25 from the interior space of the vacuum-sealable bag 20.

With continuing reference to FIG. 3, following location of the one or more textile soft goods 25 within the vacuum-sealable bag 20, the mouth 24 of the vacuum-sealable bag 20 is sealed via engagement of the closure mechanism 26, and air is evacuated from the vacuum-sealable bag 20. The air may be evacuated by application of a vacuum source via the one-way valve assembly 22. Currently, however, it is preferred that the air be mechanically expelled in an automated commercial process by compressing the vacuum-sealable bag 20 with the one or more textile soft goods 25 contained therein. Such mechanical compression could be provided, for example, by a press or other industrial machine. Following such mechanical compression, the release and initial expansion of the textile soft goods 25 contained therein create a vacuum condition within the vacuum-sealable bag 20. Preferably, a combination of the hoop strength of the vacuum-sealable bag 20 and the pressure differential created will establish an equilibrium in which the expansion forces of the one or more textile soft goods 25 is counteracted, whereby the textile soft goods 25 will be maintained in a compressed condition within the vacuum-sealable bag 20. It is believed that a volume of space consumed collectively by textile soft goods constituting a bedding set can be reduced by at least about 75% as a result of such packaging.

Alternatively, the one or more textile soft goods 25 could be vacuum-sealed within the vacuum-sealable bag 20 (i.e., sealed within the bag 20 under a vacuum condition) in a vacuum chamber of an industrial machine in an automated commercial process. Furthermore, such machine could further include compression of the textile soft goods prior to evacuation of the air. In any event, regardless of how the packaging of the one or more textile soft goods within the bag is accomplished, it is preferred that the vacuum-sealable bag already have been formed and that the one or more textile soft goods are inserted and arranged within the vacuum-sealable bag. However, it is contemplated that the vacuum-sealable bag itself could be formed during such packaging process. Additionally, it is contemplated that the one or more textile soft goods themselves first could be compressed prior to insertion within the vacuum-sealable bag 20, or alternatively, inserted in an uncompressed condition.

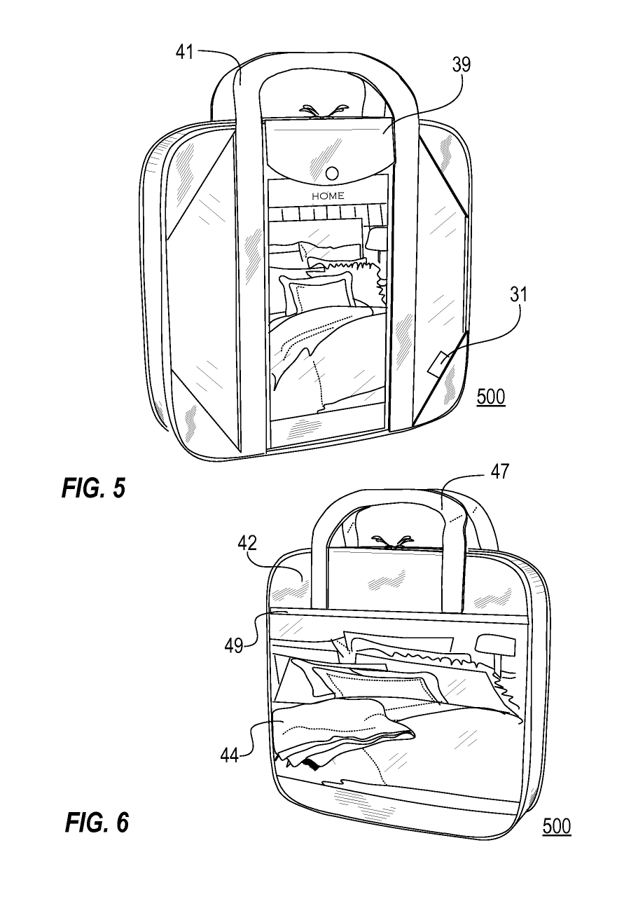

A representative bag 21 following such compression having a reduced size and volume, with the one or more textile soft goods 25 maintained therein in a compressed condition, is also shown in FIG. 3. The bag 20 is shown located within an interior space 32 of retail packaging, which retail packaging in this illustration comprises a case 30. The case 30 has a generally rectangular profile with rounded corners, and a front face of the case 30 is connected to the rest of the case 30 along only a portion of a single side of the case 30, which serves as a hinge, and is disconnected from the case 30 along each of the other three sides of the case 30, thereby forming a lid 34, as illustrated in FIG. 3. The lid 34 is capable of transitioning between an open position, in which the three disconnected sides of the lid 34 are spaced from respective sides of the case 30 as illustrated in FIG. 3, and a closed position, in which the three disconnected sides of the lid 34 are secured by a closure mechanism 36 adjacent to respective sides of the case 30, as illustrated in FIG. 4. The closure mechanism 36 may or may not be similar to the closure mechanism 26 of the vacuum-sealable bag 20. In the preferred embodiment described above, the closure mechanism 36 comprises a zipper assembly extending around the three disconnected sides of the case 30 at a front edge of the case 30. When the lid 34 is in the closed position, the zipper assembly can be used to transition the case 30 between an open state and a closed state. FIG. 4 illustrates the case 30 in the closed state. As will be appreciated, the case 30 preferably is configured to be opened and then reclosed such that the case 30 is reusable by a consumer after the vacuum-sealable bag 21 has been removed therefrom by the consumer.

In at least some preferred embodiments in accordance with aspects of the invention, the front face 30 comprises one or more transparent portions 35 and may include, for example, portions formed from polyvinyl. Preferably, one or more portions of the vacuum-sealable bag 20 are comprised of a transparent material, and the vacuum-sealable bag 20 and the case 30 are configured such that one or more of the arranged contents of the vacuum-sealable bag 20 are viewable therethrough from an exterior of the case 30 when the case 30 is in its closed state. It will be appreciated that this allows for a consumer to view a pattern of a bedding component disposed within the vacuum-sealable bag 20 from an exterior of the case 30 when the one or more textile soft goods include bedding components.

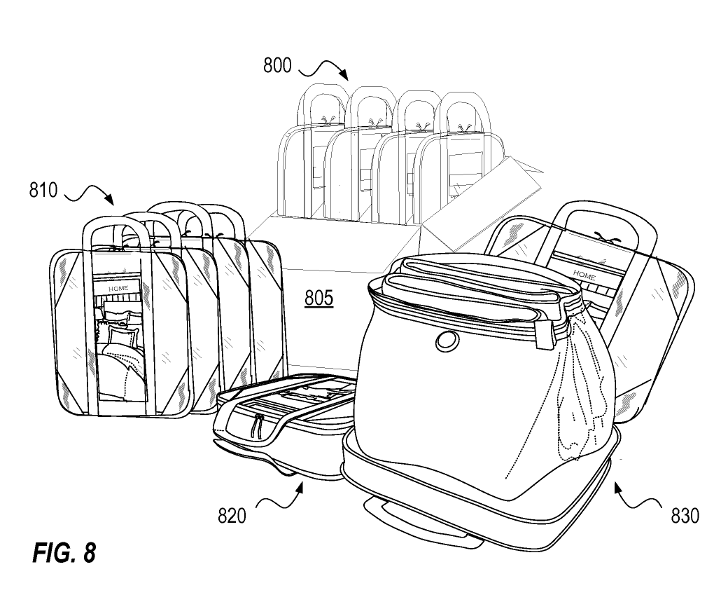

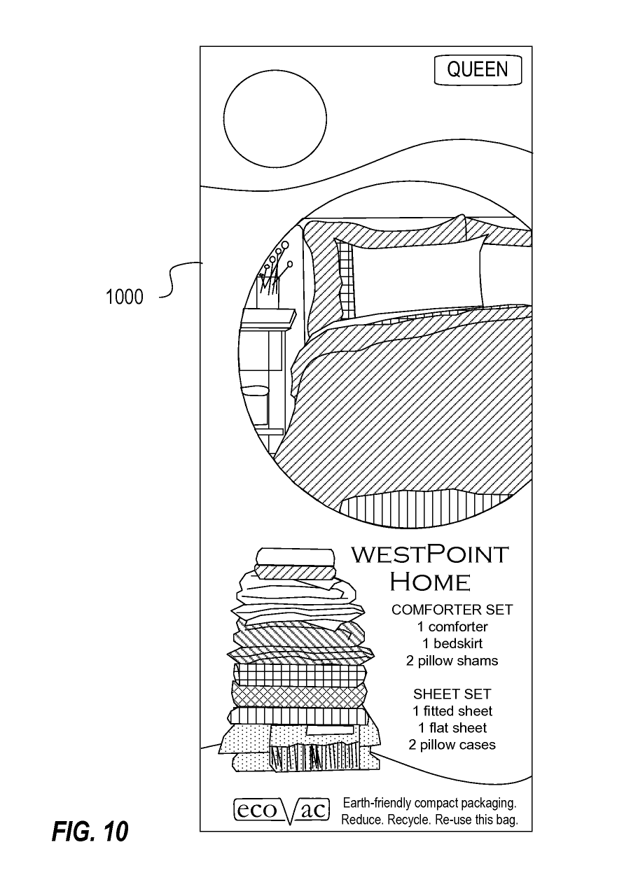

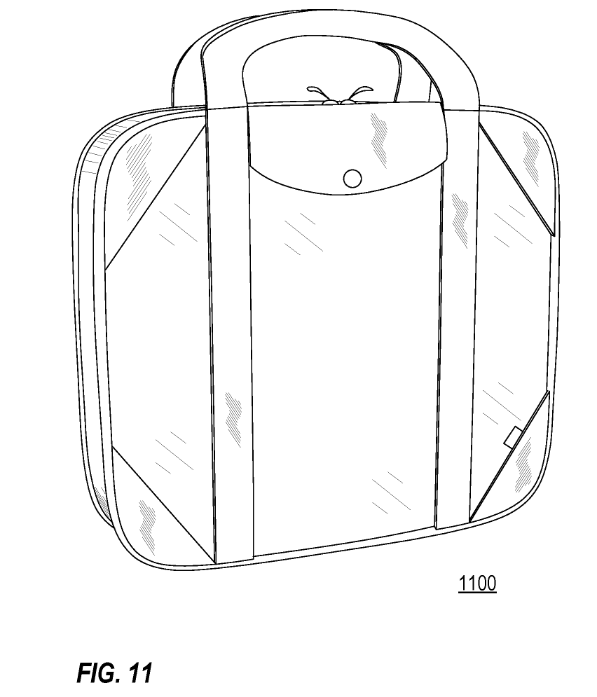

In at least some preferred embodiments, the corners of the front face are covered with an opaque material. Further, an outer perimeter of the front face preferably includes quarter-inch piping. Additionally, the front face preferably further includes a front non-woven loop handle 36, which comprises a continuous portion of non-woven material secured to an exterior of the front face 34 of the case 30. In at least some preferred embodiments, the front face further comprises a transparent pocket 37 defined between two layers of transparent material, such as, for example, polyvinyl, and open at the top for insertion of printed material. Preferably, the transparent pocket 37 is defined by securement of a smaller planar section of plastic which corresponds to the size of the pocket 37 to a larger planar section of plastic which corresponds to the size of the front face 34. The smaller section of plastic may be secured on an interior or exterior of the case 30. Preferably, the printed material comprises a card insert 33 that identifies the textile soft goods contained in the vacuum-sealable bag 21 as being a bedding set, and that further identifies the reusability of both the vacuum-sealable bag 21 and the case 30. The card insert also preferably identifies a size of the textile soft goods, such as, for example, the size of a particular bed that a bedding set fits. The card insert is physically associated with the vacuum-sealable bag 21 by its placement in the pocket 37 of the case 30 in which the vacuum-sealable bag 21 is contained. A backside of the card insert 33, through which front graphics thereof are visible, is shown in FIG. 3 and illustrates the fact that the card insert 33 is visible through the interior side of the lid 34 when the case 30 is open. Alternatively, the card insert 33 may be sufficiently thick that graphics on one side are not viewable on another side, and different or the same information and graphics may be presented on the opposite sides of the card insert. Another card insert representative of the same information and graphics being presented on both sides of the card insert is shown, for example, in FIG. 8, and another exemplary card insert is shown in FIG. 10. In variants, the printed media may comprise an adhesive label that is attached to the vacuum-sealable bag, to the case containing the vacuum-sealable bag, or a combination of both. The printed media further may comprises a bar code including the foregoing or similar information.

In at least some preferred embodiments, the case 30 is sized and dimensioned such that the interior space 32 is entirely consumed by the vacuum-sealable bag 21 contained therein. In this respect, the phrase “entirely consumed” as used herein is intended to indicate that substantially all of the space is consumed, although it will be appreciated that it is likely that some nominal amount of space may exist between one or more of the inner surfaces of the case 30 defining the interior space 32 and one or more outer surfaces of the vacuum-sealable bag 21.

FIG. 5 is a front perspective view of another preferred case 500. The case 500 additionally includes a pocket flap 39 that is adjoined to the front face between two straight portions of the front non-woven loop handle 41. The pocket flap 39 preferably extends over the quarter-inch piping and lays generally flat against the pocket of the case 500. In at least one preferred embodiment, the pocket flap 39 includes a custom branded button that secures the pocket flap to the exterior of the card pocket. When the pocket flap 39 is secured, the pocket flap 39 covers the opening of the pocket. The case also may include a logo tab 31, as illustrated for example in FIG. 5, indicative of the brand or the manufacturer of the textile soft goods product.

FIG. 6 is a rear perspective view of the case 500. The rear face of the case 500 comprises a top portion 42 and a bottom portion 44, separated by a lip 49 running horizontally across the rear face of the outer case. The top portion 42 is opaque and includes a rear non-woven loop handle 47, similar to the front non-woven loop handle 41. Furthermore, the bottom portion 44 of the rear face includes a planar sheet of a transparent material such as polyvinyl which is secured to a main section of the bottom portion so as to define a rear pocket which is configured to receive and display printed media, as illustrated in FIG. 6. Additionally, an outer perimeter of the rear face of the case 500 is lined with quarter-inch piping, as shown in FIG. 6. Preferably, a side wall extends between the front and rear faces of the case 500 on all four sides of the case 500, separating the front face of the case 500 from the rear face of the case 500. This sidewall is preferably reinforced with non-woven card stock.

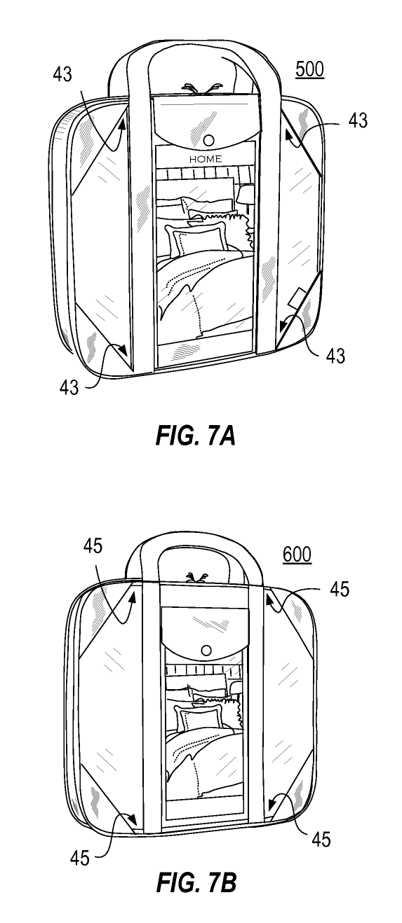

FIG. 7A is a front perspective view of the preferred case 500 for comparison with the front perspective view of another preferred case 600 shown in FIG. 7B. Case 600 represents a variation on case 500, wherein a distance between vertical sections of the front handles and the corner portions of the front face differs as between the cases 500,600 (best seen at areas 43 of case 500 and areas 45 of case 600).

FIG. 8 illustrates preferred apparatus representative of packaging systems and methods in accordance with aspects and features of the invention. More specifically, FIG. 8 illustrates at 800 the packaging of four consumer textile soft goods products within a single shipping container comprising a shipping box 805 (the grouping 810 of the four products is shown raised and extending from the box 805 for illustration purposes; additionally, grouping 810 is representative of grouping 800 without the box 805). Each of the textile soft goods products includes a reusable case having a reusable vacuum-resealable bag that, in turn, contains one or more textile soft goods constituting, in some preferred embodiments, a bedding set. A representative product is shown in the closed state at 820, and in an open state at 830 with the vacuum-sealable bag also opened. The shipping box 805 may be shipped to a wholesaler, distributor, retailer, or consumer. Upon receipt, a retailer preferably displays the bedding set products for retail sale by removing the products from the shipping box and arranging each product on a retail shelf such that each one substantially consumes the same amount of retail shelf space, with the products identifying a particular size of bed being arranged one behind the other in a horizontal column, and with each column for a different size of bed being arranged side by side.

Notably, although each of the four textile soft goods products has the same dimensions, each holds a bedding set of a different size for a different size of bed in this preferred illustration, i.e., for a twin bed, for a double bed, for a queen bed, and for a king bed. In fact, in such preferred embodiments, a single sized case and a single sized vacuum-sealable bag are configured to receive and retain various sized bedding sets, preferably by varying the amount of compression of the bedding set accordingly. It is anticipated that the greater the compression required, the greater the pressure differential will be between the pressure in the interior space of a vacuum-sealable bag and a pressure exterior thereto.

For example, and in further regard to this point, in an exemplary implementation the first case contains a bedding set for a king size bed, the second case contains a bedding set for a queen size bed, the third case contains a bedding set for a full size bed, and the fourth case contains a bedding set for a twin sized bed. This is accomplished by varying a level of compression of each of the vacuum-sealable bags. Preferably, the vacuum-sealable bag containing the king-sized bedding set is sealed at a first level of compression resulting in a first pressure differential; the vacuum-sealable bag containing the queen-sized bedding set is sealed at a second level of compression resulting in a second pressure differential less than the first pressure differential; the vacuum-sealable bag containing the full-sized bedding set is sealed at a third level of compression resulting in a third pressure differential less than the second pressure differential, and the vacuum-sealable bag containing the twin-sized bedding set is sealed at a fourth level of compression resulting in a fourth pressure differential less than the third pressure differential.

It further should be understood and appreciated that, in at least some preferred embodiments, a vacuum-sealable bag containing textile soft goods may possess an insufficient hoop strength to retain the textile soft goods in a compressed condition therein without a pressure differential upon pressure equalization and loss of the pressure differential. In such embodiments wherein the vacuum-sealable bag is located within separate retail packaging, it is preferred that such retail packaging be capable of retaining the textile soft goods in a compressed condition within the vacuum-sealable bag. In some preferred embodiments the opaque corner portions are configured to enhance the hoop strength of the case. In at least some preferred embodiments, especially those in which the vacuum-sealable bag serves as the retail packaging, the vacuum-sealable bag itself possesses a hoop strength that is sufficient to maintain the textile soft goods in a compressed condition within the vacuum-sealable bag upon equalization of the pressure in the interior space of the vacuum-sealable bag and a pressure exterior to the vacuum-sealable bag.

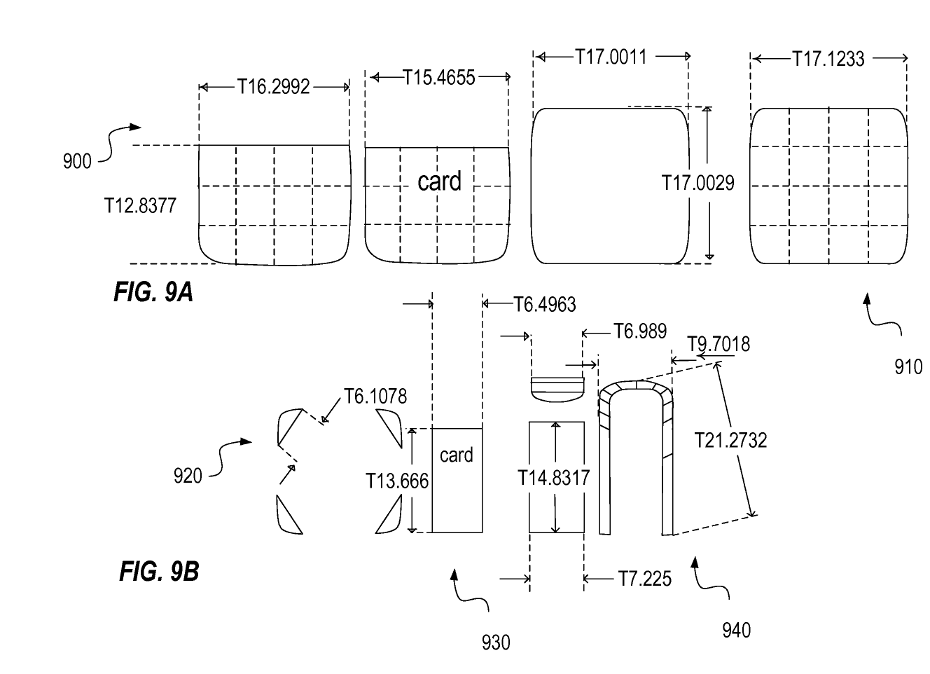

FIGS. 9A-9B are schematic illustrations of components and dimensions of a preferred case in accordance with one or more aspects of the present invention. The components shown include: a card 900 for a back pocket of a case; panels 910 for a case; corner reinforcements 920; a card insert 930 for a front pocket of a case; and a loop 940 representative of each of front and rear handles of a case.

FIG. 10 illustrates an exemplary card insert 1000 of some preferred embodiments in accordance with one or more aspects of the invention.

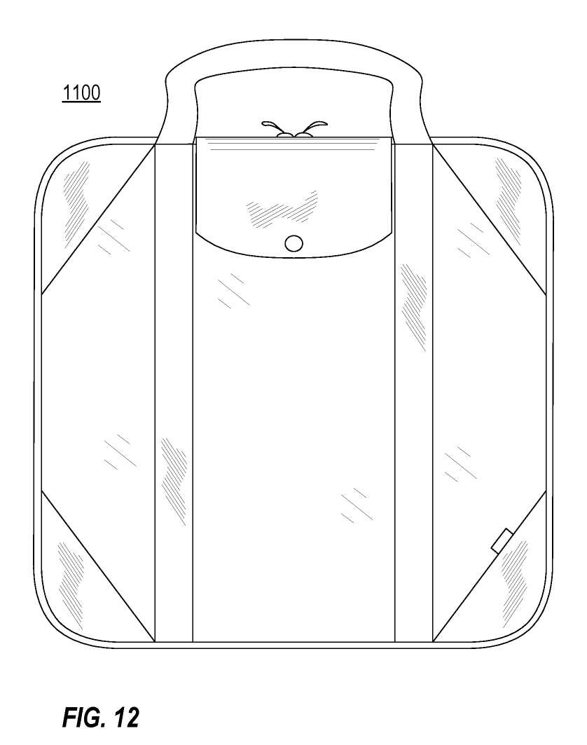

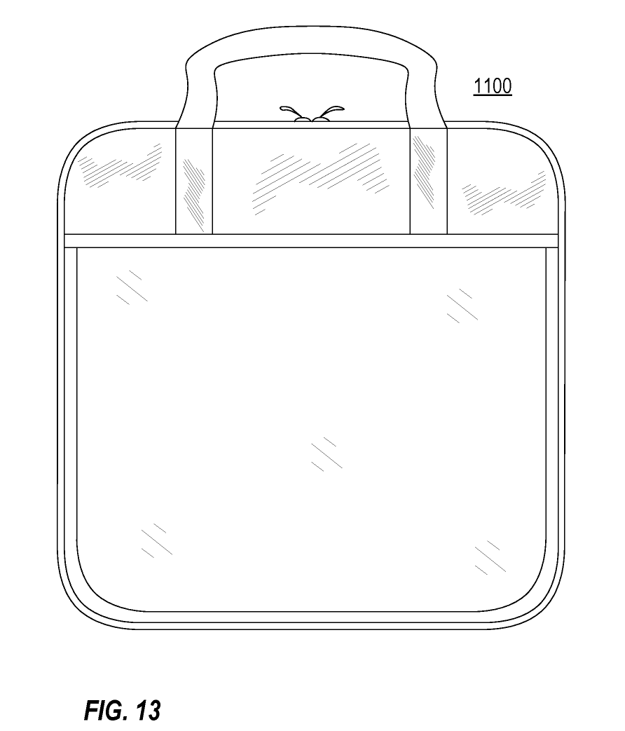

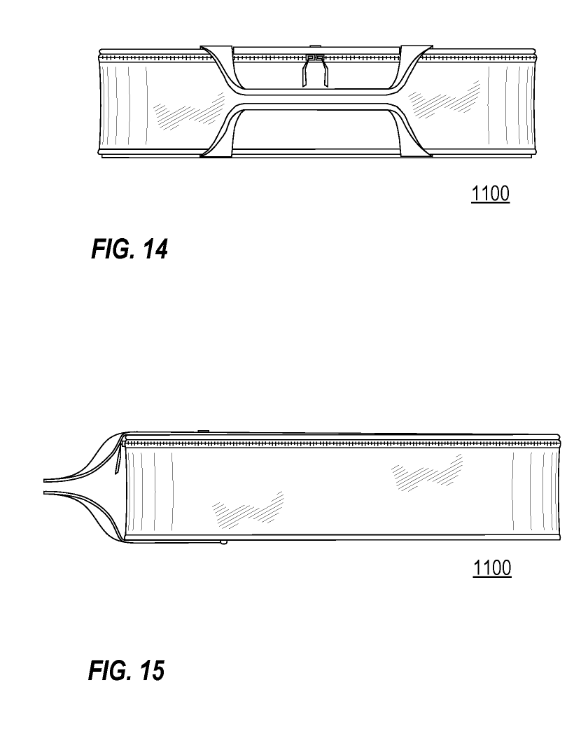

FIG. 11 is a front perspective view of another preferred case 1100 in accordance with one or more aspects of the invention. Additionally, FIG. 12 is a front plan view of the case 1100; FIG. 13 is a rear plan view of the case 1100; FIG. 14 is a top plan view of the case 1100; and FIG. 15 is a side plan view of the case 1100.

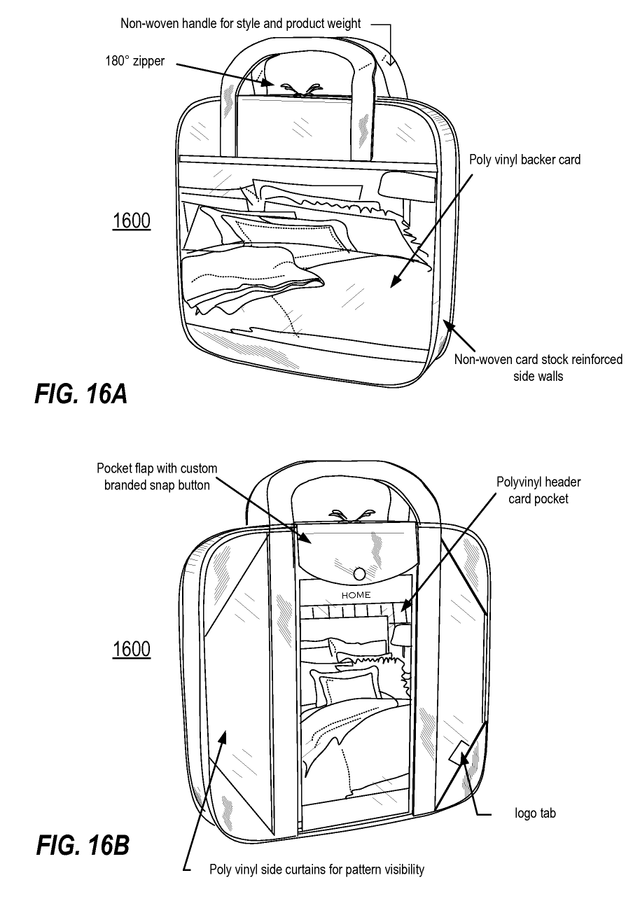

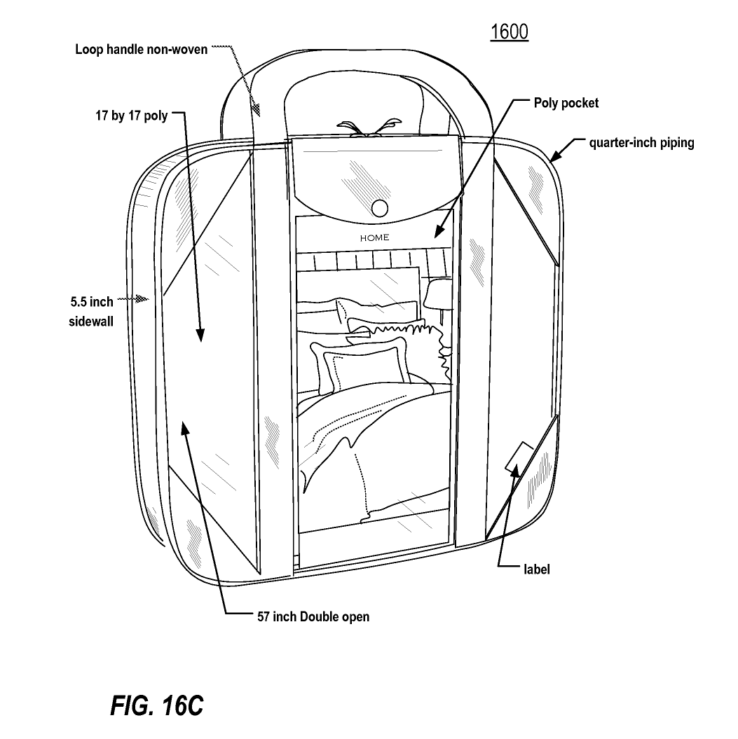

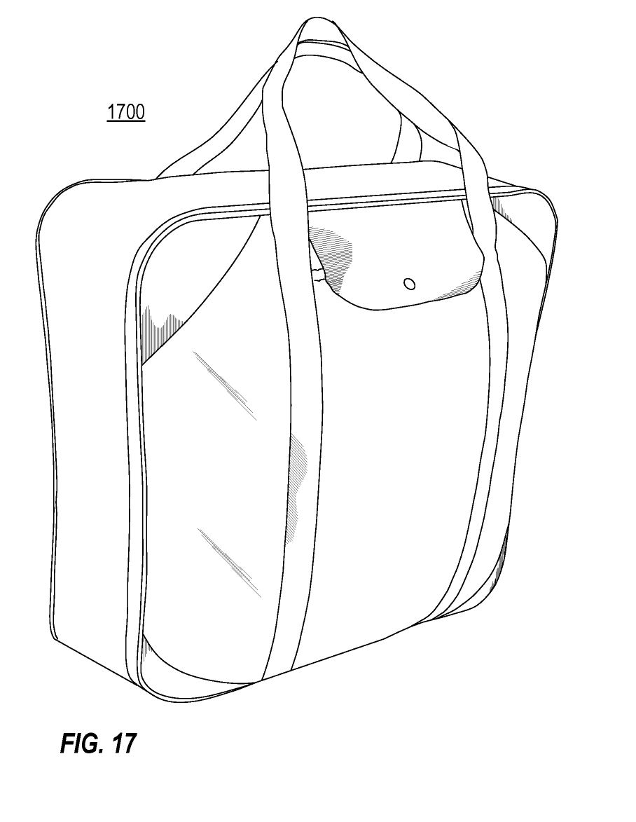

FIG. 16A is a rear perspective view of another preferred case 1600 in accordance with one or more aspects of the invention. Additionally, FIG. 16B is a front perspective view of the case 1600; and FIG. 16C is another front perspective view of the case 1100.

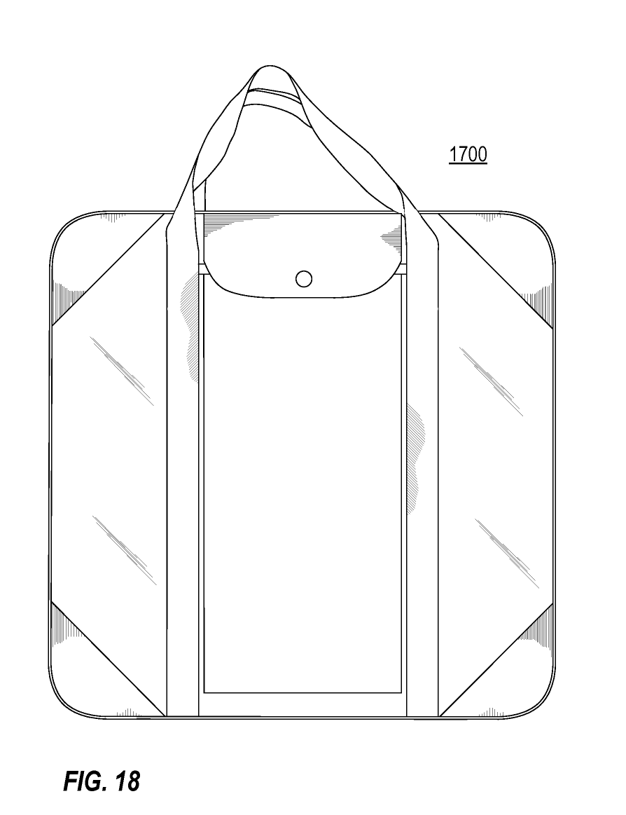

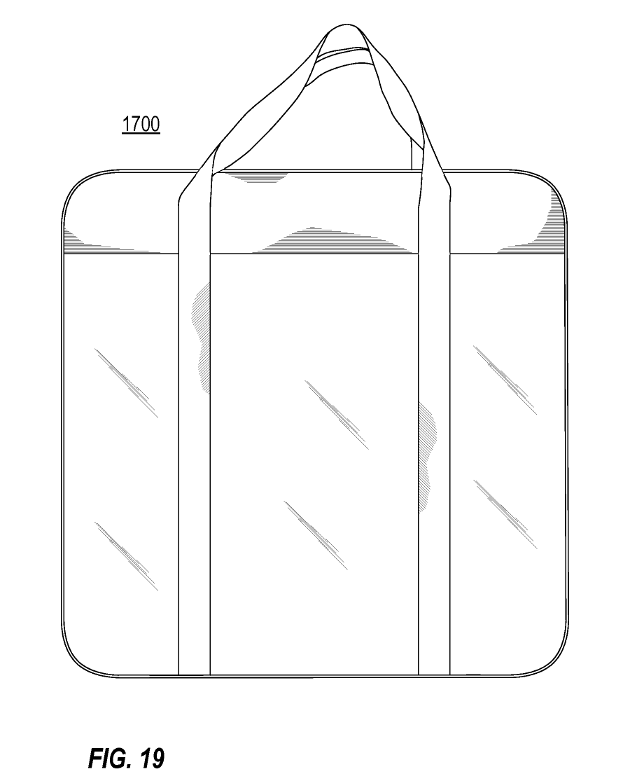

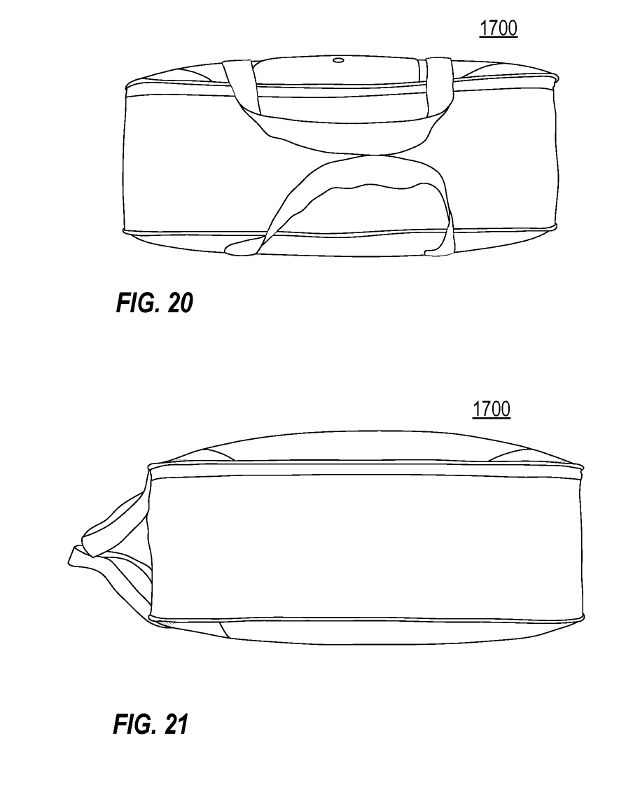

FIGS. 17-21 illustrate yet another preferred case 1700 in accordance with one or more aspects of the present invention. In particular, FIG. 17 is a front perspective view of case 1700 in accordance with one or more aspects of the invention. Additionally, FIG. 18 is a front plan view of the case 1700; FIG. 19 is a rear plan view of the case 1700; FIG. 20 is a top plan view of the case 1700; and FIG. 21 is a side plan view of the case 1700. Case 1700 includes therein textile soft goods vacuum-packed within a reusable vacuum-sealable bag. As will be appreciated from these drawings, the vacuum-sealable bag entirely consumes the interior space of the case 1700 and has resulted in this instance in the bulging of the case 1700. Moreover, case 1700 is illustrative of a case having sufficient hoop strength to maintain the textile soft goods in the vacuum-sealable bag in a compressed condition upon a loss of a pressure differential.

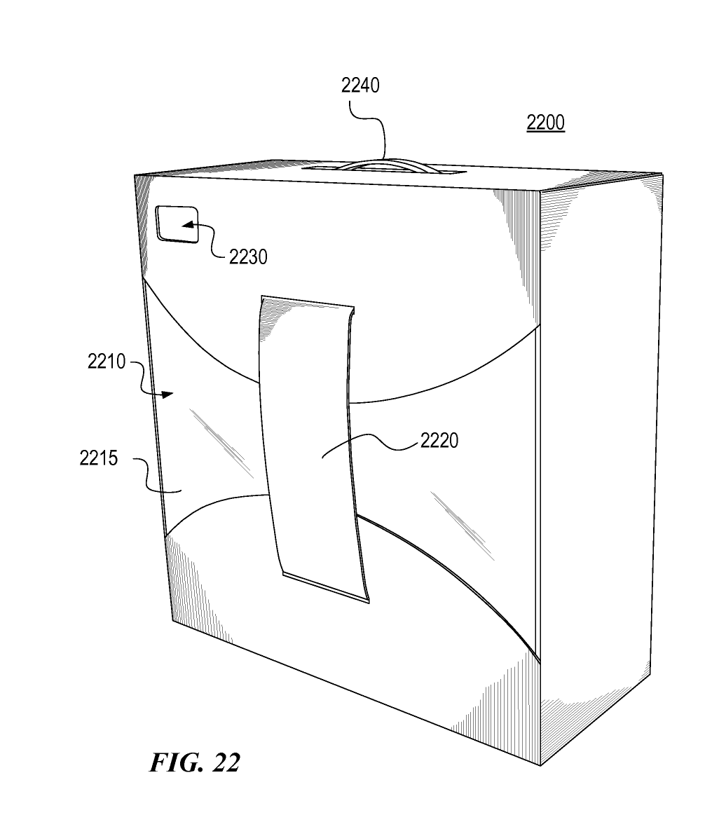

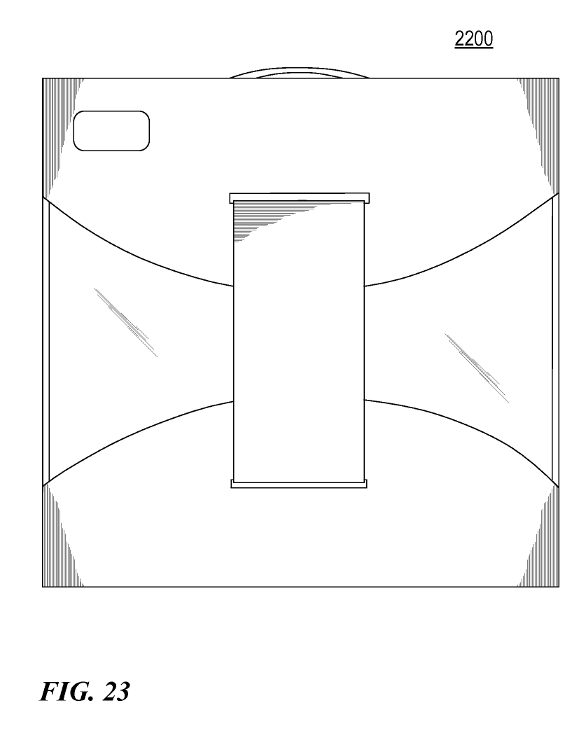

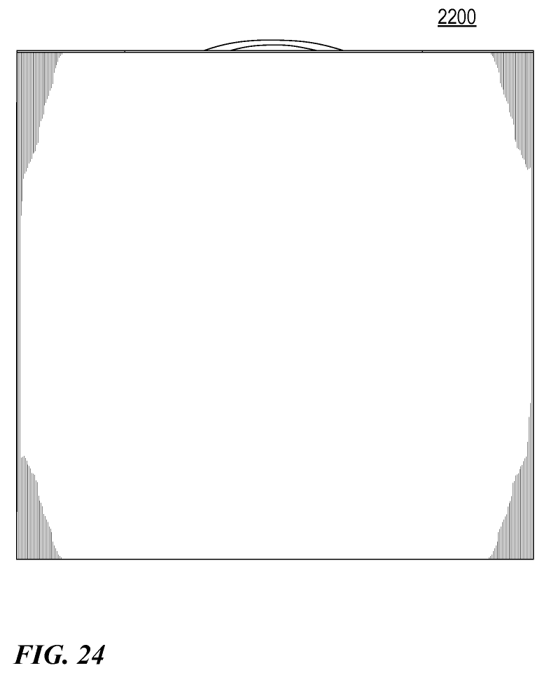

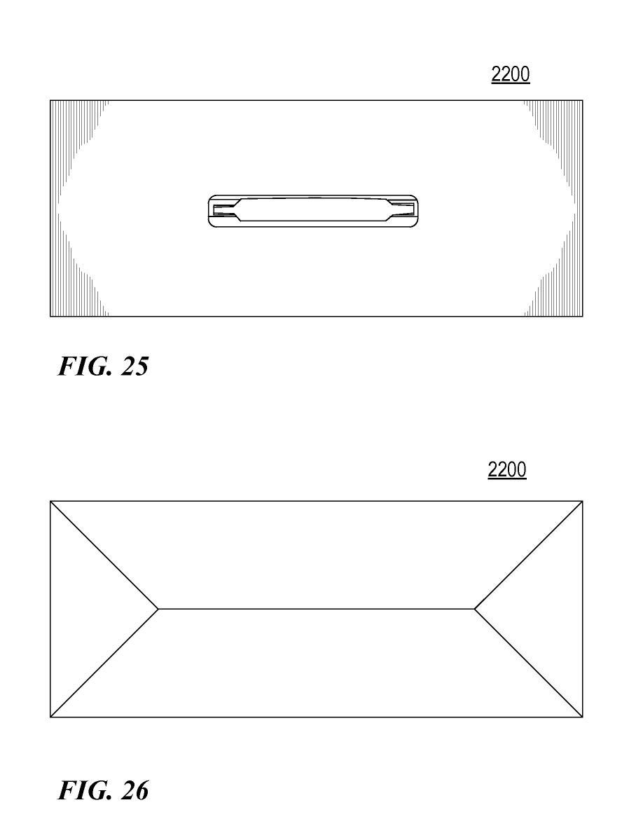

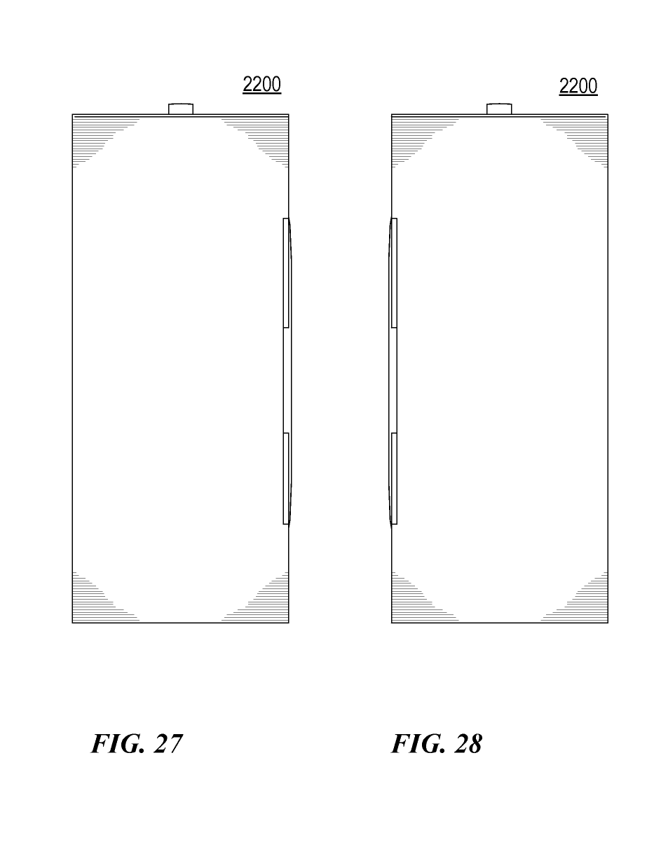

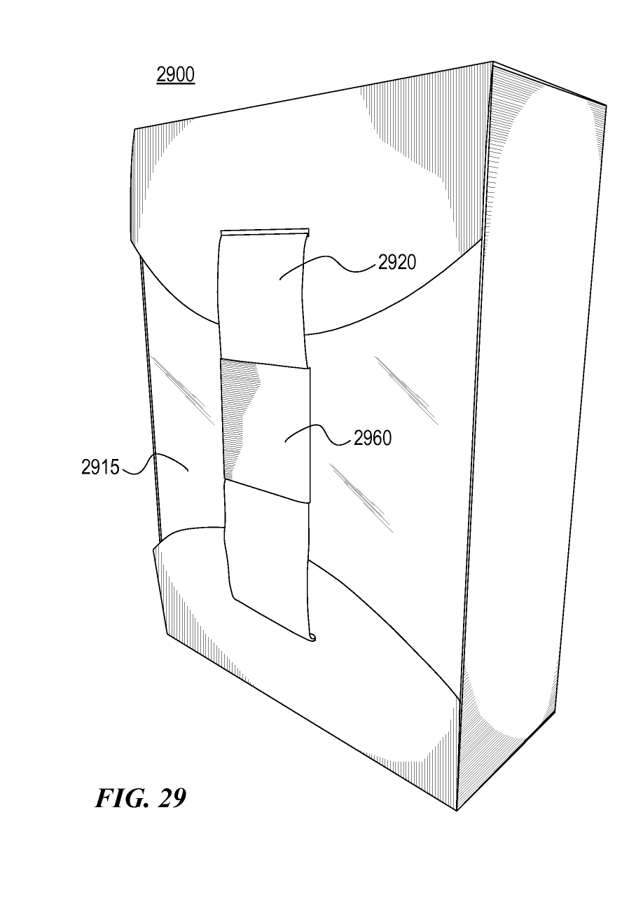

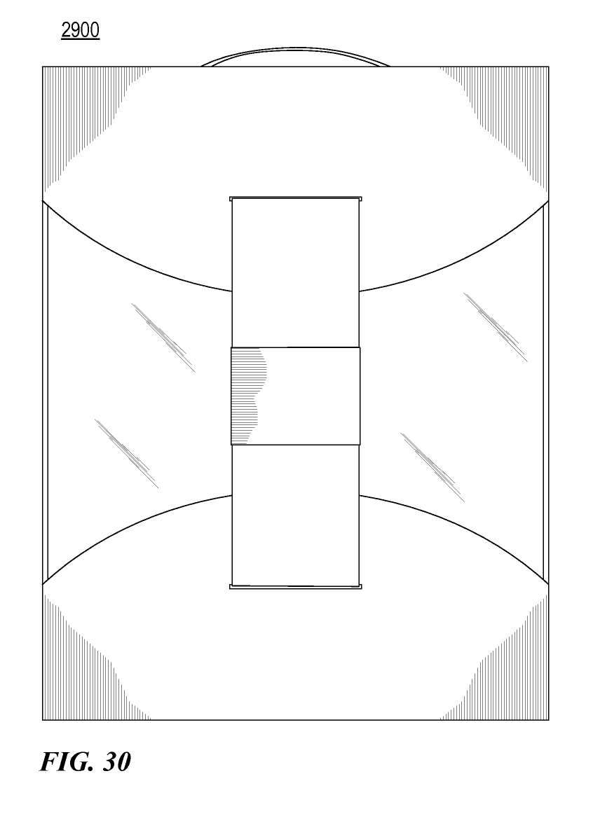

FIGS. 22-28 illustrate retail packaging comprising a preferred box 2200 in accordance with one or more aspects of the present invention. In particular, FIG. 22 is a front perspective view of box 2200; FIG. 23 is a front plan view of the box 2200; FIG. 24 is a rear plan view of the box 2200; FIG. 25 is a top plan view of the box 2200; FIG. 26 is a bottom plan view of the box 2200; FIG. 27 is a plan view of a first side of the box 2200; and FIG. 28 is a plan view of the other side of the box 2200. The box 2200 preferably is made from post-consumer cardboard or other stock, includes a handle 2240, and includes media printed thereon (not shown). The box 2200 further defines both an opening 2210 that is covered by an opaque sheet of material 2215 and a window 2230 through which one or more contents of the box preferably are visible, including a portion of the textile soft goods that are contained within the reusable vacuum-sealable bag inside the box 2200. Preferably, the window 2230 is sufficient to quickly convey to a consumer a color, a pattern, or both, of the textile soft goods contained in the box 2200. A bridge 2220 extends across the opening 2210 and also include printed media. The bridge 2220 preferably is installed on the box 2200 by inserting opposite ends of the bridge 2220 through slots formed in the front surface of the box above and below the opening 2210. The information displayed on the bridge 2220 preferably varies according to the particular size for which the contained textile soft goods are applicable, whereby during packaging of such products, the same boxes having the identical printed media on its surfaces may be used regardless of the particular size to which particular textile soft goods correspond. Additionally, in variations of the box 2200, the sheet of material 2215 may be transparent or translucent, or omitted altogether for better viewing of the contents of the box 2200.

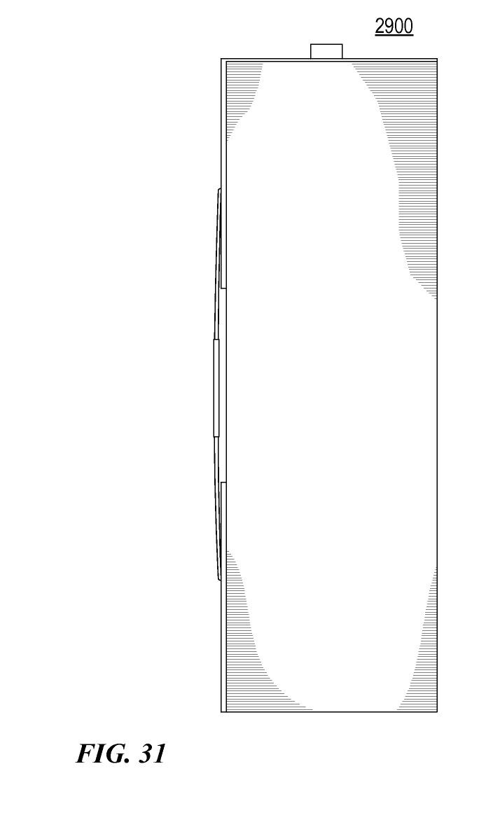

FIGS. 29-31 illustrate retail packaging comprising another preferred box 2900 in accordance with one or more aspects of the present invention. In particular, FIG. 29 is a front perspective view of box 2900; FIG. 30 is a front plan view of the box 2900; and FIG. 31 is a side plan view of the box 2900. The box 2900 is similar to that of box 2200, but does not include a window like the window 2230 of box 2200. Box 2900 further includes a wrapper 2960 that is placed around the bridge 2920 and that itself preferably includes printed media thereon. In this variant, the bridge 2920 may not include printed media thereon, with the printed media that otherwise would be on the bridge 2920 instead being printed on the wrapper 2960. Additionally, in variations of the box 2900, the sheet of material 2915 may be transparent or translucent, or omitted altogether for better viewing of the contents of the box 2900.

From the foregoing, it will be appreciated that environmentally friendly systems are disclosed in accordance with one or more aspects of the invention that feature product packaging that is reused post purchase by consumers. For example, such a system includes packaging textile soft goods products for retail sale as described above and advertising, as a selling point to consumers, the reusability of the vacuum-resealable bags in which the textile soft goods products are sold at retail. Another exemplary system includes purchasing textile soft goods products as described above by consumers, and removing the textile soft goods from the vacuum-resealable bags for—and reusing the vacuum-resealable bags by—vacuum-packing items therein by the consumers.

Another such system includes packaging textile soft goods products for retail sale as described above; shipping the products to retailers for displaying; individually displaying to consumers the products for retail sale by setting out the products on store shelves; removing by the consumers the vacuum-resealable bags from the respective retail packaging and removing the textile soft goods thereof from the respective vacuum-resealable bags; and reusing by the consumers the vacuum-resealable bags by vacuum-packing items therein.

### Inventive Business Model Utilizing Regional Packaging Centers for Manufacturers and Retailers

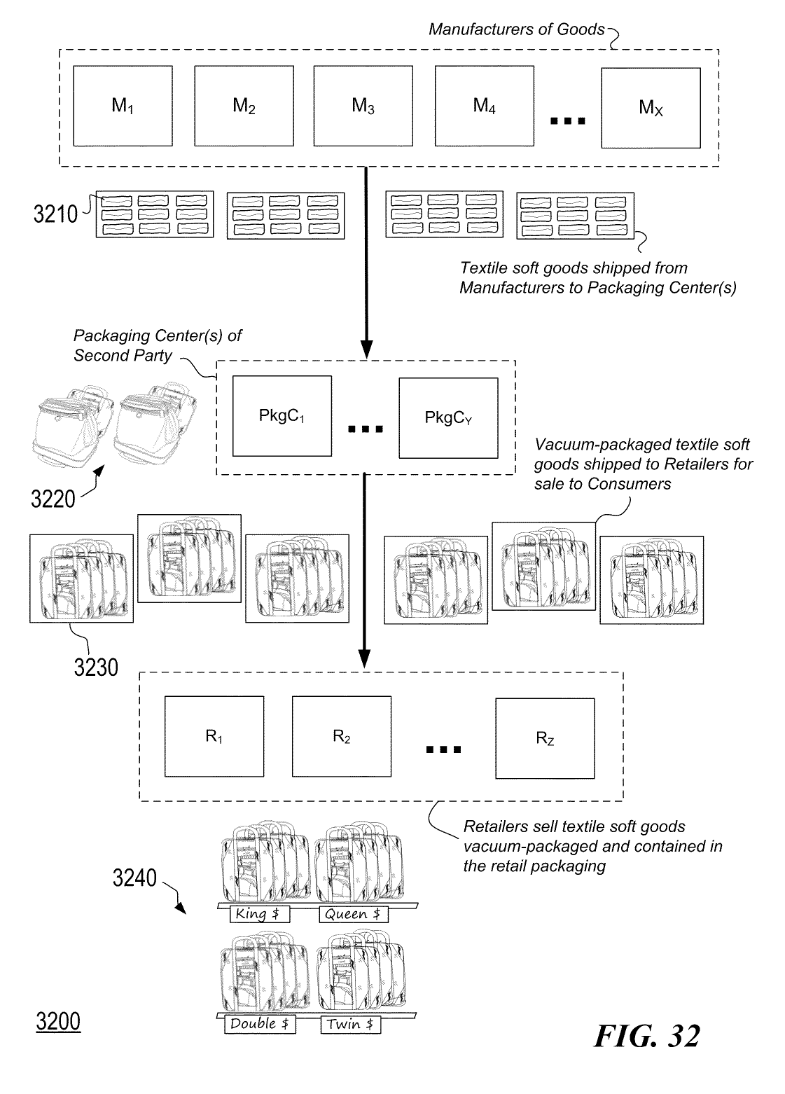

The invention further encompasses inventive business models, of which the system 3200 illustrated in FIG. 32 is representative. In accordance with system 3200, one or more first party manufacturers, represented by M₁, M₂, M₃, and M₄ through M_{X}, each manufacture textile soft goods, such as those represented at 3210 shown together with eight other textile soft goods in a shipping container. The system 3200 also includes one or more packaging centers of a first party, represented by PkgC₁ through PkgC_{Y}. The packaging centers may be regional. Preferably, each manufacturer ships its manufactured textile soft goods to a packaging center. The textile soft goods received from a manufacturer at a packaging center are then packaged within a reusable vacuum-resealable bag as set forth above, and may further be located and contained within retail packaging in accordance with one or more aspects and features of the invention disclosed above, as illustrated at 3220 in FIG. 32. It is contemplated that one or more textile soft goods from a manufacturer may be combined with one or more textile soft goods of another manufacturer during this process, if desired, such as where comforters may come from a manufacturer that is different from a manufacturer of sheet sets with which the comforters are combined and packaged as a single retail product; however, it is preferred that the textile soft goods manufactured and sold for a first company are not combined with the textile soft goods manufactured and sold for another company. The vacuum-packed textile soft goods contained in retail packaging are then shipped in containers 3230 from the packaging centers to the respective retailers that carry such products, represented by R₁, R₂, R₃, and R₄ through R_{Z}.

The products are then removed by the retailers from the shipping containers 3230 and are displayed on shelves, as represented at 3240 in FIG. 32, for sale to consumers at retail. Each product includes the compression-packed textile soft goods contained within retail packaging including a vacuum-sealable bag, preferably as received from the packaging center at which the product was packed. It will be noted that, as illustrated, each product in the retail display arrangement at 3240 in FIG. 32 takes up the same retail shelf space even though the products are for four different sizes of beds in this illustration.

Products sold at retail may be packed for retail sale at a packaging center even where such products are competing products of different companies. In this regard, it is possible that the benefits of the environmentally friendly packaging in accordance with aspects of the invention may outweigh any competitive advantages to be gained by one competitor using such environmentally friendly packaging to the exclusion of other competitors. Indeed, it is possible that society overall would benefit from adoption of such environmentally friendly packaging of most, if not all, textile soft goods, and even other goods that may be appropriate for such packaging. Moreover, the packaging centers may be geographically dispersed throughout a region or country for accommodating efficient shipment to and from such packaging centers.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

For example, while the foregoing description has focused on the inclusion of a vacuum-sealable bag located within retail packaging and containing textile soft goods, it is contemplated that the vacuum-sealable bag itself may serve as the retail packaging for the textile soft goods at retail. In this example, the printed media may be an adhesive label that is adhered to the vacuum-sealable bag itself. It is further contemplated that textile soft goods may be sold at retail to consumers in reusable vacuum-sealable bags wherein the textile soft goods, while contained within the vacuum-sealable bags, are not sealed under pressure in the vacuum-sealable bags; are not subject to a pressure differential existing across the vacuum-sealable bag between the interior of the vacuum-sealable bag and an exterior of the vacuum-sealable bag; or both. Nevertheless, it is believes that such retail products are environmentally friendly as a result of the reusable characteristics of the vacuum-sealable bags by consumers post purchase.

1. A consumer textile soft goods product for retail sale, comprising:
(a) a vacuum-resealable bag having,
(i) air impermeable walls defining an interior space of the vacuum-resealable bag,
(ii) a one-way valve assembly configured to permit air to be evacuated through the one-way valve assembly from the interior space of the vacuum-resealable bag but to preclude air from entering the interior space of the vacuum sealable bag through the one-way valve assembly, and
(iii) a closure mechanism configured to seal a mouth of the vacuum-resealable bag in an airtight manner,
(iv) wherein the vacuum-resealable bag is configured to maintain a vacuum condition within the interior space when the closure mechanism seals the mouth of the vacuum-resealable bag and air is evacuated through the one-way valve assembly from the interior space defined by the vacuum-resealable bag, and
(v) wherein the vacuum-resealable bag is configured to be opened and then reclosed such that the vacuum-resealable bag is reusable by a consumer for vacuum-packing after the one or more textile soft goods have been removed from the interior space of the vacuum-resealable bag; and
(b) one or more textile soft goods located within the interior space of the vacuum-resealable bag.

2. The consumer textile soft goods product for retail sale of claim 1, wherein the one or more textile soft goods located within the interior space of the vacuum-resealable bag are maintained in a compressed condition resulting from a pressure differential existing between a pressure in the interior space of the vacuum-resealable bag and a pressure exterior to the vacuum-resealable bag.

3. The consumer textile soft goods product for retail sale of claim 2, further comprising retail packaging comprising a case in which the vacuum-resealable bag containing the textile soft goods is contained, wherein a hoop strength of the case is sufficient to maintain the textile soft goods in a compressed condition within the vacuum-resealable bag upon equalization of the pressure in the interior space of the vacuum-resealable bag and a pressure exterior to the vacuum-resealable bag.

4. The consumer textile soft goods product for retail sale of claim 1, wherein the one-way valve assembly is located in a wall of the vacuum-resealable bag and is configured to receive a nozzle of a vacuum cleaner hose, whereby the air within the interior space may be evacuated using a vacuum cleaner.

5. The consumer textile soft goods product for retail sale of claim 1, wherein the one-way valve assembly of the vacuum-resealable bag is configured to expel air from the interior space thereof upon rolling up of the vacuum-resealable bag by a consumer for creating a pressure differential between a pressure in the interior space of the bag and a pressure exterior to the bag.

6. The consumer textile soft goods product for retail sale of claim 1, wherein the textile soft goods comprise a plurality of individual bedding components constituting a bedding set.

7. The consumer textile soft goods product for retail sale of claim 1, wherein none of the textile soft goods are individually packaged.

8. The consumer textile soft goods product for retail sale of claim 1, further comprising printed media identifying the one or more textile soft goods contained in the interior space of the vacuum-resealable bag, the printed media being physically associated with the vacuum-resealable bag for viewing by a consumer at retail sale.

9. The consumer textile soft goods product for retail sale of claim 8, wherein the printed media further identifies the reusability of the vacuum-resealable bag.

10. The consumer textile soft goods product for retail sale of claim 8, wherein the printed media comprises an adhesive label that is attached to the vacuum-resealable bag.

11. The consumer textile soft goods product for retail sale of claim 10, wherein retail packaging of the textile soft goods product for retail sale comprises the vacuum-resealable bag.

12. The consumer textile soft goods product for retail sale of claim 1, wherein at least a portion of the vacuum-resealable bag is transparent such that one or more contents of the vacuum-resealable bag are viewable there through.

13. The consumer textile soft goods product for retail sale of claim 1, further comprising retail packaging defining an interior space in which the vacuum-resealable bag containing the textile soft goods is contained.

14. The consumer textile soft goods product for retail sale of claim 1, further comprising retail packaging comprising a case in which the vacuum-resealable bag containing the textile soft goods is contained, the case configured to be opened and then reclosed such that the case is reusable by a consumer after the vacuum-resealable bag containing the bedding set has been removed therefrom by the consumer.

15. The consumer textile soft goods product for retail sale of claim 14, wherein at least a portion of the vacuum-resealable bag is transparent such that one or more contents of the vacuum-resealable bag are viewable there through, and at least a portion of the case is transparent such that one or more contents of the vacuum-resealable bag are further viewable there through, the vacuum-resealable bag being arranged within the case such that the one or more contents of the vacuum-resealable bag are viewable through both the case and the vacuum-resealable bag by a prospective customer at retail sale.

16. The consumer textile soft goods product for retail sale of claim 14, further comprising printed media identifying the one or more textile soft goods contained in the interior space of the vacuum-resealable bag, the printed media being physically associated with the vacuum-resealable bag for viewing by a consumer at retail sale, wherein the printed media comprises an adhesive label that is attached to the case containing the vacuum-resealable bag.

17. The consumer textile soft goods product for retail sale of claim 14, further comprising printed media identifying the one or more textile soft goods contained in the interior space of the vacuum-resealable bag, the printed media being physically associated with the vacuum-resealable bag for viewing by a consumer at retail sale, wherein the case comprises a pocket, the pocket including a transparent panel through which contents of the pocket are viewable from an exterior of the case, and wherein the printed media comprises a rigid planar member comprising a card insert that is retained within the pocket of the case.

18. The consumer textile soft goods product for retail sale of claim 17, wherein the pocket includes opposing front and rear transparent panels whereby contents of the pocket are viewable through both the front and rear transparent panels.

19. The consumer textile soft goods product for retail sale of claim 14, wherein the case defines an interior containment space that is practically entirely consumed by the vacuum-resealable bag contained therein.

20. The consumer textile soft goods product for retail sale of claim 19, wherein the case comprises opposed transparent panels, and wherein corners of the transparent panels include non-transparent components that cover the corners of the vacuum-resealable bag and that reinforce the case and contribute to the hoop strength of the case.

21-281. (canceled)
